(19) United States
(12) Patent Application Publication
(10) Pub. No.: US 2025/0253959 A1
(43) Pub. Date: Aug. 7, 2025

(54) OBJECT LOCALIZATION USING RADIO FREQUENCY SENSING AND COMPUTER VISION

(71) Applicant: QUALCOMM Incorporated, San Diego, CA (US)

(72) Inventors: Ziqi WANG, Los Angeles, CA (US); June NAMGOONG, San Diego, CA (US); Taesang YOO, San Diego, CA (US); Wooseok NAM, San Diego, CA (US); Akash Sandeep DOSHI, San Diego, CA (US); Yucheng DAI, San Diego, CA (US); Tao LUO, San Diego, CA (US)

(21) Appl. No.: 18/433,192

(22) Filed: Feb. 5, 2024

(51) Int. Cl. H04B 17/10; H04B 7/0404

(52) U.S. Cl. CPC H04B 17/101; H04B 7/0404

(57) ABSTRACT

In some aspects, a user equipment (UE) may receive, from a network node, sensing configuration information for a sensing session, the sensing configuration information indicating one or more transmission reception points (TRPs). The UE may transmit, to the network node, sensing result information associated with one or more images that are representative of channel energy responses (CERs) for respective TRPs of the one or more TRPs. Numerous other aspects are described.

### FIELD OF THE DISCLOSURE

Aspects of the present disclosure generally relate to object localization and, for example, to object localization using radio frequency sensing and computer vision.

### BACKGROUND

In some examples, a wireless communication network may support an integrated sensing and communication (ISAC) service. “ISAC” refers to a system that provides sensing capabilities (e.g., radio frequency (RF) sensing capabilities) using the same system and infrastructure (e.g., a wireless communication network) that is used for communication. ISAC may sometimes be referred to as joint communication and radar (JCR). One or more devices in the wireless communication network, such as a user equipment (UE), a network node, a base station, a transmission reception point (TRP), and/or another wireless communication device may perform RF sensing via the wireless communication network (e.g., using one or more RF signals or wireless communication signals).

RF sensing is a technology that enables wireless communication devices to acquire information about characteristics of the environment and/or objects within the environment. RF sensing uses RF signals to determine the distance (range), angle, and/or instantaneous linear velocity, among other examples, of objects. RF sensing may provide a range of functionality for wireless communication devices, such as object detection, object recognition (e.g., vehicle, human, or animal), object tracking, environment monitoring, motion monitoring, high accuracy localization, health monitoring, immersive extended reality (XR) application, home monitoring, weather monitoring, automotive operations (e.g., maneuvering, navigation, and/or parking), pedestrian and/or obstacle monitoring for roadways and/or railways, unmanned aerial vehicle (UAV) operations (e.g., UAV intrusion detection, UAV tracking, and/or collision avoidance), industrial operations (e.g., automated guided vehicles (AGV), automated robots, and/or pedestrian monitoring), tracking, and/or activity recognition, among other examples.

RF sensing may include communication-assisted sensing and/or sensing-assisted communication. “Communication-assisted sensing” refers to a wireless communication device, such as a UE or a TRP, performing RF sensing using one or more hardware components and/or radio resources that are associated with communication. For example, the wireless communication device may obtain information indicative of characteristics of the environment and/or objects within the environment using RF signals (e.g., New Radio RF signals or other RF signals associated with wireless communication). “Sensing-assisted communication” refers to a wireless communication device using sensing results to perform one or more communication operations. For example, sensing results may improve communication performance, such as by enabling more accurate beamforming, faster beam failure recovery, and/or reduced overhead for channel state information (CSI) tracking, among other examples.

### SUMMARY

Some implementations described herein relate to a user equipment (UE). The UE may include one or more memories and one or more processors coupled to the one or more memories. The one or more processors may be configured to cause the UE to receive, from a network node, sensing configuration information for a sensing session, the sensing configuration information indicating one or more transmission reception points (TRPs). The one or more processors may be configured to cause the UE to transmit, to the network node, sensing result information associated with one or more images that are representative of channel energy responses (CERs) for respective TRPs of the one or more TRPs.

Some implementations described herein relate to a network node. The network node may include one or more memories and one or more processors coupled to the one or more memories. The one or more processors may be configured to cause the network node to transmit, for one or more UEs, sensing configuration information for a sensing session, the sensing configuration information indicating one or more TRPs. The one or more processors may be configured to cause the network node to receive sensing result information for respective UEs of the one or more UEs, the sensing result information being associated with one or more images that are representative of CERs for respective TRPs of the one or more TRPs.

Some implementations described herein relate to a method performed by a UE. The method may include receiving, from a network node, sensing configuration information for a sensing session, the sensing configuration information indicating one or more TRPs. The method may include transmitting, to the network node, sensing result information associated with one or more images that are representative of CERs for respective TRPs of the one or more TRPs.

Some implementations described herein relate to a method performed by a network node. The method may include transmitting, for one or more UEs, sensing configuration information for a sensing session, the sensing configuration information indicating one or more TRPs. The method may include receiving sensing result information for respective UEs of the one or more UEs, the sensing result information being associated with one or more images that are representative of CERs for respective TRPs of the one or more TRPs.

Some implementations described herein relate to a non-transitory computer-readable medium that stores a set of instructions. The set of instructions, when executed by one or more processors of a UE, may cause the UE to receive, from a network node, sensing configuration information for a sensing session, the sensing configuration information indicating one or more TRPs. The set of instructions, when executed by one or more processors of the UE, may cause the UE to transmit, to the network node, sensing result information associated with one or more images that are representative of CERs for respective TRPs of the one or more TRPs.

Some implementations described herein relate to a non-transitory computer-readable medium that stores a set of instructions. The set of instructions, when executed by one or more processors of a network node, may cause the network node to transmit, for one or more UEs, sensing configuration information for a sensing session, the sensing configuration information indicating one or more TRPs. The set of instructions, when executed by one or more processors of the network node, may cause the network node to receive sensing result information for respective UEs of the one or more UEs, the sensing result information being associated with one or more images that are representative of CERs for respective TRPs of the one or more TRPs.

Some implementations described herein relate to an apparatus. The apparatus may include means for receiving, from a network node, sensing configuration information for a sensing session, the sensing configuration information indicating one or more TRPs. The apparatus may include means for transmitting, to the network node, sensing result information associated with one or more images that are representative of CERs for respective TRPs of the one or more TRPs.

Some implementations described herein relate to an apparatus. The apparatus may include means for transmitting, for one or more UEs, sensing configuration information for a sensing session, the sensing configuration information indicating one or more TRPs. The apparatus may include means for receiving sensing result information for respective UEs of the one or more UEs, the sensing result information being associated with one or more images that are representative of CERs for respective TRPs of the one or more TRPs.

Aspects generally include a method, apparatus, system, computer program product, non-transitory computer-readable medium, user device, user equipment, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network, in accordance with the present disclosure.

FIG. 2 is a diagram illustrating example components of a device, in accordance with the present disclosure.

FIGS. 3A and 3B are diagrams illustrating examples of radio frequency (RF) sensing, in accordance with the present disclosure.

FIG. 4 is a diagram illustrating an example associated with multi-static cooperative RF sensing, in accordance with the present disclosure.

FIGS. 5A and 5B are diagrams illustrating an example of object localization using multi-static cooperative RF sensing, in accordance with the present disclosure.

FIG. 6 is a diagram of an example associated with object localization using RF sensing and computer vision, in accordance with the present disclosure.

FIG. 7 is a diagram of an example associated with object localization using RF sensing and computer vision, in accordance with the present disclosure.

FIG. 8 is a diagram of an example associated with a visualization operation for object localization using RF sensing and computer vision, in accordance with the present disclosure.

FIG. 9 is a diagram of an example associated with a transformer architecture for object localization using RF sensing and computer vision, in accordance with the present disclosure.

FIG. 10 is a flowchart of an example process associated with object localization using RF sensing and computer vision, in accordance with the present disclosure.

FIG. 11 is a flowchart of an example process associated with object localization using RF sensing and computer vision, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Wireless communication signals (e.g., radio frequency (RF) signals configured to carry orthogonal frequency division multiplexed (OFDM) symbols) transmitted between wireless communication devices (e.g., a user equipment (UE) or a network node) can be reused for RF sensing. Using wireless communication signals for RF sensing can be considered consumer-level radar with advanced detection capabilities that enable, among other things, touchless or device-free interaction with a device or system. “RF sensing” may be a radar operation performed by a wireless communication device, such as a UE, a network node, or another device (such as a wireless local area network (WLAN) access point or a transmission reception point (TRP)), using wireless communication signals. RF sensing may also be referred to as environment sensing, radar sensing, WLAN sensing, Wi-Fi sensing, and/or wireless sensing, among other examples. The wireless communication signals used to perform RF sensing may be cellular communication signals (for example, LTE signals, NR signals, and/or 6G signals) or WLAN signals (for example, Wi-Fi signals), among other examples. High-frequency communication signals, such as millimeter wave signals, may be beneficial to use as RF sensing signals because the higher frequency provides a more accurate range (for example, distance) detection and/or motion detection.

In some examples, wireless communication devices may perform RF sensing to obtain localization information for one or more target objects in an environment. The target object(s) may be a device-free object (e.g., may be an object that does not include a device that is capable of communicating with the wireless communication devices or via a wireless communication network). The localization information may include an object detection indicator (e.g., indicating whether the target object is detected), and/or an indication of a location of the target object (e.g., geographic coordinates of the target object). In some examples, RF sensing may be cooperative multistatic sensing in which multiple devices obtain sensing data used to obtain or determine the localization information for a target object.

For example, one or more devices may perform one or more measurements of the reflection(s) of a sensing signal (e.g., that is reflected or otherwise deflected by a target object) to obtain sensing data. The sensing data may include information that is indicative of one or more characteristics of the target object. For example, the sensing data may include a signal strength (for example, a reference signal received power (RSRP)), a received raw signal sample, a channel delay profile, one or more Doppler measurements (for example, Doppler per channel tap), a channel impulse response (CIR), a channel energy response (CER), CSI, CQI, time delay measurements, and/or an angle of arrival (AoA) (for example, AoA per channel tap), among other examples. In some aspects, the one or more devices may transmit the sensing data to another device (e.g., a network node) for processing. For example, a network node (e.g., a base station or a network server device) may perform processing of sensing data collected from the one or more devices. The network node may receive position data of the one or more receiving devices (e.g., from a positioning operation with a UE or from a known position of a network node or TRP). The network node may determine the localization information for the target object using the collected sensing data, the position of a transmitting device (e.g., that transmits the sensing signal(s), and the positions of respective receiving devices (e.g., that receive and/or measure the sensing signal(s)).

However, there are many challenges with accurately obtaining localization information for target objects of interest in a dynamic environment. For example, a target object may be static in the environment. It may be difficult to distinguish between the target object and other static objects in the environment, such as trees, buildings, or other objects that may be permanent fixtures in the environment. Therefore, sensing data alone may be insufficient for obtaining the localization information for target objects of interest in the environment. As another example, the quantity of target objects in the environment may be dynamic and may change over time. As a result, there may be a dynamic quantity of outputs for localization information for target objects of interest in a dynamic environment, increasing the complexity of identifying target objects and determining the localization information for the target objects.

As another example, there may be a dynamic quantity of devices performing RF sensing in the environment. For example, the quantity of devices (e.g., UEs) participating in the cooperative multi-static RF sensing operation may change over time. As a result, there may be a dynamic quantity of sensing data inputs for localization information for target objects of interest in the dynamic environment. The dynamic quantity of inputs may increase the complexity of identifying target objects and determining the localization information for the target objects. Further, a location of the receiving devices may be dynamic and may change over time. For example, the receiving devices may be mobile devices that move throughout the environment over time. As a result, the relationship between sensing data and target object localization information may change over time. Additionally, sensing data from the same device may result in different localization information over time because the device may be moving over time.

Various aspects relate generally to object localization (e.g., device-free object localization) using RF sensing and computer vision. Some aspects more specifically relate to using visualization techniques to jointly represent information associated with a cooperative multi-static RF sensing operation. For example, the visualization techniques may enable a device (e.g., a network node and/or a UE) to generate one or more images that jointly represent information indicated by CIRs or CERs measured by a UE and positions of the UE and a TRP (e.g., a transmitting device that transmits a sensing signal measured by the UE to obtain the CIRs). In some aspects, a network node may obtain localization information for one or more objects in the environment by using the one or more images and a transformer model (e.g., a detection transformer (DETR) model).

In some aspects, the one or more images may be representative of CERs for respective TRPs in the environment. The one or more images may include one or more ellipses. For example, a UE may measure a CIR for a transmitting device (e.g., a TRP) over time. From the measured CIR, the UE may determine a time of flight (ToF) for different paths of a signal (e.g., a sensing signal) transmitted by the transmitting device. Using the different ToFs and/or a CER, the UE and/or a network node may determine that a target object is located somewhere on an ellipse having focal points that correspond to the transmitting device location (e.g., a TRP location) and the UE location. Using cooperative multi-static RF sensing, CERs measured by multiple devices (e.g., multiple UEs) may be obtained to indicate multiple ellipses defining potential locations of target object(s) in an environment. An intersection between two or more ellipses may be indicative of a potential object location. Therefore, using CIRs and/or CERs measured by receiving devices (e.g., UEs) of different transmitting devices (e.g., TRPs or network nodes 110) in a cooperative multi-static RF sensing scenario, a device (e.g., a network node 110 and/or a network server) may determine potential locations of target object(s) in an environment from the image(s).

In some aspects, a network node may transmit, and a UE may receive, sensing configuration information for a sensing session, the sensing configuration information indicating one or more TRPs. The UE may transmit, and the network node may receive, sensing result information associated with one or more images that are representative of CERs for respective TRPs of the one or more TRPs. In some aspects, the sensing result information may include the CERs for the respective TRPs. In such examples, the network node may collect CERs from one or more UEs and generate the one or more images using the CERs. In other aspects, the sensing result information may include the one or more images and/or information associated with the one or more images, such as summary vectors for respective images. In such examples, the UE may generate the one or more images using CERs measured by the UE.

The network node may obtain localization information for one or more objects using the one or more images. For example, the network node may obtain the localization information by providing the one or more images and/or information associated with the one or more images as an input to a DETR model. For example, the network node may provide, as an input to the DETR model (e.g., to an encoder of the DETR model), one or more summary vectors for respective images included in the one or more images. A summary vector may be obtained via providing an image as an input to a vision transformer. The network node may obtain, from the encoder of the DETR model, one or more output vectors. The network node may provide, to a decoder of the DETR model, the one or more output vectors and one or more object queries. The network node may obtain, via an output of the decoder of the DETR model, an indication of the localization information.

Particular aspects of the subject matter described in this disclosure can be implemented to realize one or more of the following potential advantages. In some examples, by using visualization-based data representation for a cooperative multi-static RF sensing operation, the described techniques can be used to improve an accuracy of localization information for target object(s) in a dynamic environment with changing UE positions and/or changing quantities of UEs participating in the cooperative multi-static RF sensing operation. For example, by a UE transmitting (e.g., to a network node) sensing result information associated with one or more images that are representative of CERs obtained by the UE, the network node may obtain localization information for one or more target objects in a dynamic environment with improved accuracy and reduced complexity (e.g., because the visualization-based data representation from the one or more images enables the use of a computer-vision-based transformer architecture for obtaining the localization information).

In some aspects, by using a transformer-based architecture to obtain the localization information, the described techniques can be used with varying quantities of UEs participating in the cooperative multi-static RF sensing operation (e.g., the transformer-based architecture may support inputs having dynamic lengths). In some aspects, by providing one or more object queries as an input to the DETR model, the described techniques can be used with dynamic or varying quantities of objects in the environment. For example, the one or more object queries may define outputs of the DETR model for a quantity of potential target objects. If an object is detected, a corresponding output may include information indicative of the localization information for the object. If an object is not detected, a corresponding output may be empty. As a result, the described techniques can support obtaining localization information for varying quantities of objects in the environment over time.

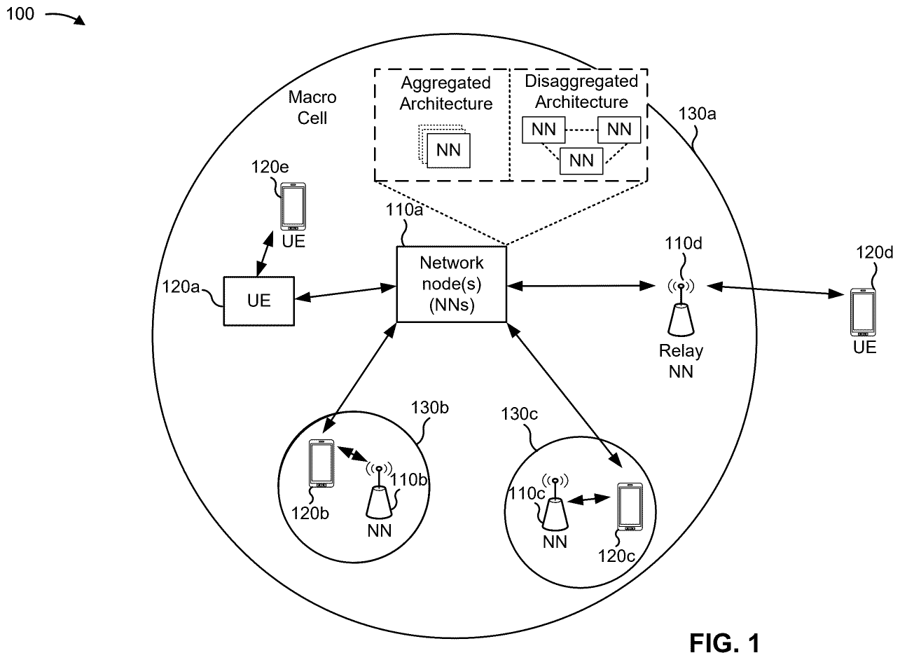

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

The wireless communication network 100 may include one or more wired and/or wireless networks. For example, the wireless communication network 100 may include a peer-to-peer (P2P) network, a cellular network (e.g., a long-term evolution (LTE) network, a code division multiple access (CDMA) network, an open radio access network (O-RAN), a New Radio (NR) network, a 3G network, a 4G network, a 5G network, a 6G network, or another type of next generation network), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or a cloud computing network, among other examples, and/or a combination of these or other types of networks. In some aspects, the wireless communication network 100 may include and/or be a P2P communication link that is directly between one or more of the devices of wireless communication network 100.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. Uplink channels may similarly include one or more control channels and one or more data channels.

In some examples, the network node 110 may be a server device. For example, the network node 110 may be a device configured to support one or more functions or services for the wireless communication network 100. As an example, the network node 110 may be a device (e.g., a server device) configured to support a location service, a positioning service, a sensing service (e.g., an ISAC service), and/or another service for the wireless communication network 100. In some examples, the network node 110 may be a component of a core network (e.g., may be a core network entity).

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”). An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

In some aspects, the UE 120 may include one or more components (such as a communication manager) configured to receive, from a network node, sensing configuration information for a sensing session, the sensing configuration information indicating one or more TRPs; and/or transmit, to the network node, sensing result information associated with one or more images that are representative of CERs for respective TRPs of the one or more TRPs. Additionally, or alternatively, the UE 120 may include one or more components (such as a communication manager) configured to receive, from a network node, sensing configuration information for a sensing session, the sensing configuration information indicating one or more TRPs; obtain, via one or more RF sensing measurements of the one or more TRPs, sensing measurement information, the sensing measurement information including CERs for respective TRP of the one or more TRPs; and/or transmit, to the network node, sensing result information that is associated with the sensing measurement information, the sensing result information being associated with one or more images that are representative of the CERs. Additionally, or alternatively, the UE 120 may be configured to perform one or more other operations described herein.

In some aspects, the network node 110 may include one or more components (such as a communication manager) configured to transmit, for one or more UEs, sensing configuration information for a sensing session, the sensing configuration information indicating one or more TRPs; and/or receive sensing result information for respective UEs of the one or more UEs, the sensing result information being associated with one or more images that are representative of CERs for respective TRPs of the one or more TRPs. Additionally, or alternatively, the network node 110 may include one or more components (such as a communication manager) configured to perform, for a sensing session, RF sensing of an area, the RF sensing indicating a zone of interest for the area; transmit, to one or more UEs, sensing configuration information for the sensing session, the sensing configuration information including an indication of one or more TRPs associated with the zone of interest; receive, for each UE included in the one or more UEs, sensing result information associated with one or more images that are representative of CERs for respective TRP of the one or more TRPs; and/or obtain, via a DETR model and using the sensing result information, localization information for one or more objects included in the zone of interest. Additionally, or alternatively, the network node 110 may be configured to perform one or more other operations described herein.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of wireless communication network 100 may perform one or more functions described as being performed by another set of devices of wireless communication network 100.

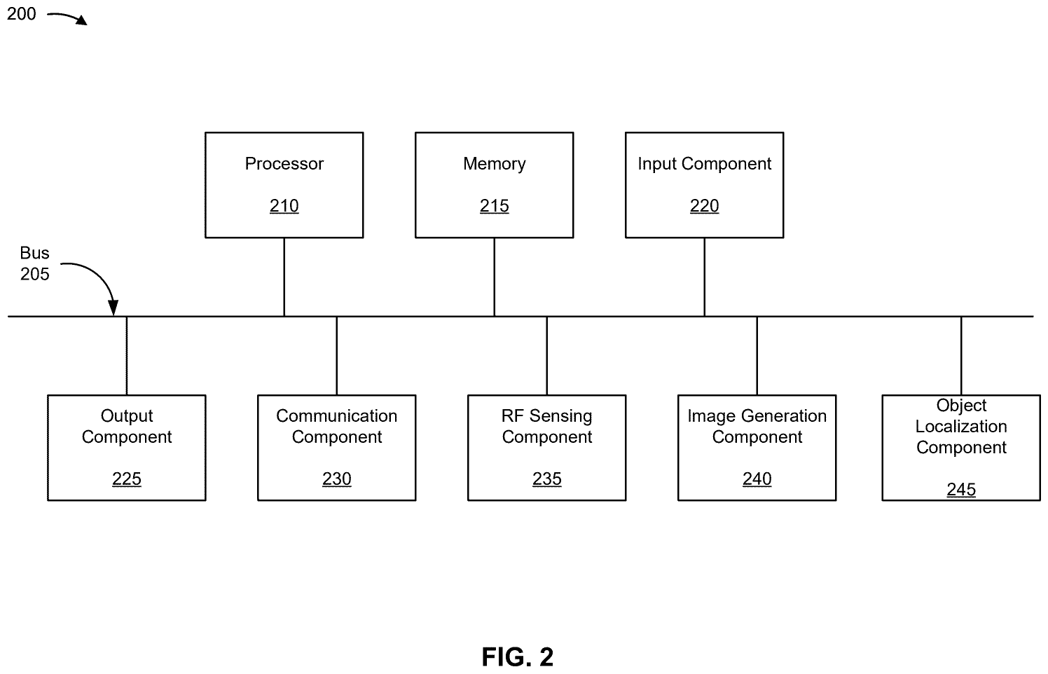

FIG. 2 is a diagram illustrating example components of a device 200, in accordance with the present disclosure. The device 200 may correspond to the UE 120, and/or the network node 110, among other examples. In some aspects, the UE 120, and/or the network node 110, among other examples may include one or more devices 200 and/or one or more components of the device 200. As shown in FIG. 2, the device 200 may include a bus 205, a processor 210, a memory 215, an input component 220, an output component 225, a communication component 230, an RF sensing component 235, an image generation component 240, and/or an object localization component 245.

The bus 205 may include one or more components that enable wired and/or wireless communication among the components of the device 200. The bus 205 may couple together two or more components of FIG. 2, such as via operative coupling, communicative coupling, electronic coupling, and/or electric coupling. For example, the bus 205 may include an electrical connection (e.g., a wire, a trace, and/or a lead) and/or a wireless bus. The processor 210 may include a central processing unit, a graphics processing unit, a microprocessor, a controller, a microcontroller, a digital signal processor, a field-programmable gate array, an application-specific integrated circuit, and/or another type of processing component. The processor 210 may be implemented in hardware, firmware, or a combination of hardware and software. In some aspects, the processor 210 may include one or more processors capable of being programmed to perform one or more operations or processes described elsewhere herein.

The memory 215 may include volatile and/or nonvolatile memory. For example, the memory 215 may include random access memory (RAM), read only memory (ROM), a hard disk drive, and/or another type of memory (e.g., a flash memory, a magnetic memory, and/or an optical memory). The memory 215 may include internal memory (e.g., RAM, ROM, or a hard disk drive) and/or removable memory (e.g., removable via a universal serial bus connection). The memory 215 may be a non-transitory computer-readable medium. The memory 215 may store information, one or more instructions, and/or software (e.g., one or more software applications) related to the operation of the device 200. In some aspects, the memory 215 may include one or more memories that are coupled (e.g., communicatively coupled) to one or more processors (e.g., processor 210), such as via the bus 205. Communicative coupling between a processor 210 and a memory 215 may enable the processor 210 to read and/or process information stored in the memory 215 and/or to store information in the memory 215.

The input component 220 may enable the device 200 to receive input, such as user input and/or sensed input. For example, the input component 220 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 225 may enable the device 200 to provide output, such as via a display, a speaker, and/or a light-emitting diode. The communication component 230 may enable the device 200 to communicate with other devices via a wired connection and/or a wireless connection. For example, the communication component 230 may include a receiver, a transmitter, a transceiver, a modem, a network interface card, and/or an antenna, among other examples.

The RF sensing component 235 may enable the device 200 to perform RF sensing (e.g., as part of an ISAC service). For example, the RF sensing component 235 may be configured to perform RF sensing using cellular communication signals (e.g., LTE signals, NR signals, and/or 6G signals) and/or WLAN signals (for example, Wi-Fi signals), among other examples. The RF sensing component 235 may include one or more processors, one or more transmitters, one or more receivers, one or more antennas, a modem, and/or other components configured to generate sensing data using measurements of wireless communication signals. For example, the RF sensing component 235 may be configured to obtain measurement information of wireless communication signals via the one or more processors 210, the input component 220, and/or the communication component 230 and then determine or generate sensing data using the measurement information.

The image generation component 240 may enable the device 200 to generate one or more images. For example, the image generation component 240 may include a computer vision model configured to generate images using input data. For example, the image generation component 240 may include one or more vision transformers. The image generation component 240 may be configured to generate one or more images using CERs of respective TRPs, as described in more detail elsewhere herein.

The object localization component 245 may enable the device 200 to generate, determine, and/or obtain localization information for one or more objects in an environment. In some examples, the object localization component 245 may enable the device 200 to generate, determine, and/or obtain localization information for device-free objects, as described in more detail elsewhere herein. The object localization component 245 may include a machine learning model, such as a detection transformer. The machine learning model may be configured to output an indication of the localization information using an input of one or more images that are representative of CERs measured by UEs or other devices, as described in more detail elsewhere herein.

The device 200 may perform one or more operations or processes described herein. For example, a non-transitory computer-readable medium (e.g., memory 215) may store a set of instructions (e.g., one or more instructions or code) for execution by the processor 210. The processor 210 may execute the set of instructions to perform one or more operations or processes described herein. In some aspects, execution of the set of instructions, by one or more processors 210, causes the one or more processors 210 and/or the device 200 to perform one or more operations or processes described herein. In some aspects, hardwired circuitry may be used instead of or in combination with the instructions to perform one or more operations or processes described herein. Additionally, or alternatively, the processor 210 may be configured to perform one or more operations or processes described herein. Thus, aspects described herein are not limited to any specific combination of hardware circuitry and software.

In some aspects, the device 200 may include means for receiving, from a network node, sensing configuration information for a sensing session, the sensing configuration information indicating one or more TRPs; and/or means for transmitting, to the network node, sensing result information associated with one or more images that are representative of CERs for respective TRPs of the one or more TRPs. Additionally, or alternatively, the device 200 may include means for receiving, from a network node, sensing configuration information for a sensing session, the sensing configuration information indicating one or more TRPs; means for obtaining, via one or more RF sensing measurements of the one or more TRPs, sensing measurement information, the sensing measurement information including CERs for respective TRP of the one or more TRPs; and/or means for transmitting, to the network node, sensing result information that is associated with the sensing measurement information, the sensing result information being associated with one or more images that are representative of the CERs.

Additionally, or alternatively, the device 200 may include means for transmitting, for one or more UEs, sensing configuration information for a sensing session, the sensing configuration information indicating one or more TRPs; and/or means for receiving sensing result information for respective UEs of the one or more UEs, the sensing result information being associated with one or more images that are representative of CERs for respective TRPs of the one or more TRPs. Additionally, or alternatively, the device 200 may include means for performing, for a sensing session, RF sensing of an area, the RF sensing indicating a zone of interest for the area; means for transmitting, to one or more UEs, sensing configuration information for the sensing session, the sensing configuration information including an indication of one or more TRPs associated with the zone of interest; means for receiving, for each UE included in the one or more UEs, sensing result information associated with one or more images that are representative of CERs for respective TRP of the one or more TRPs; and/or means for obtaining, using the sensing result information, localization information for one or more objects included in the zone of interest.

In some aspects, the means for the device 200 to perform processes and/or operations described herein may include one or more components of device 200 described in connection with FIG. 2, such as bus 205, processor 210, memory 215, input component 220, output component 225, communication component 230, the RF sensing component 235, the image generation component 240, and/or the object localization component 245.

The number and arrangement of components shown in FIG. 2 are provided as an example. The device 200 may include additional components, fewer components, different components, or differently arranged components than those shown in FIG. 2. Additionally, or alternatively, a set of components (e.g., one or more components) of the device 200 may perform one or more functions described as being performed by another set of components of the device 200.

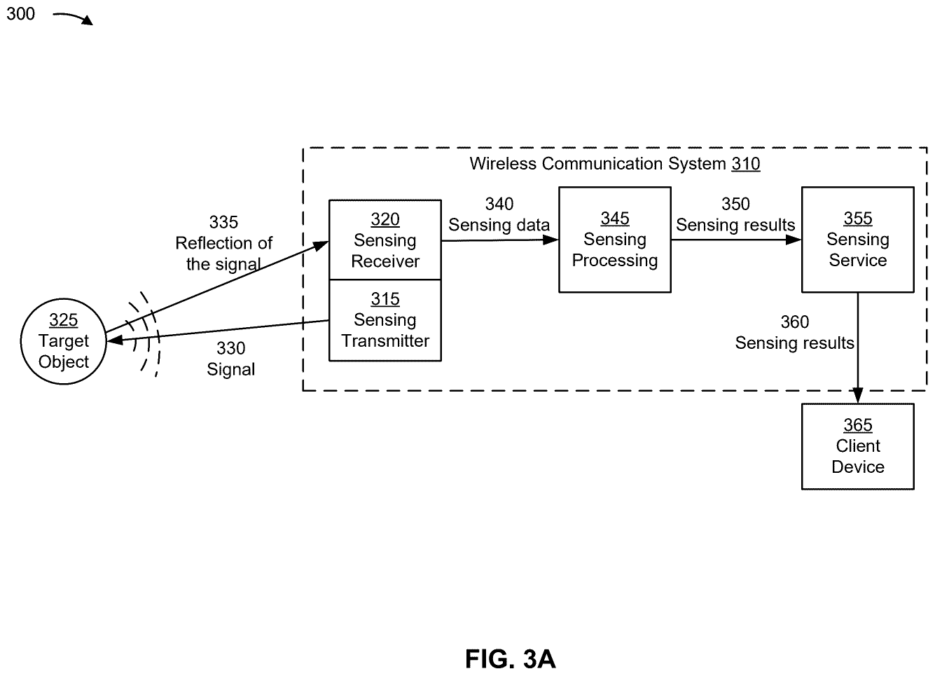

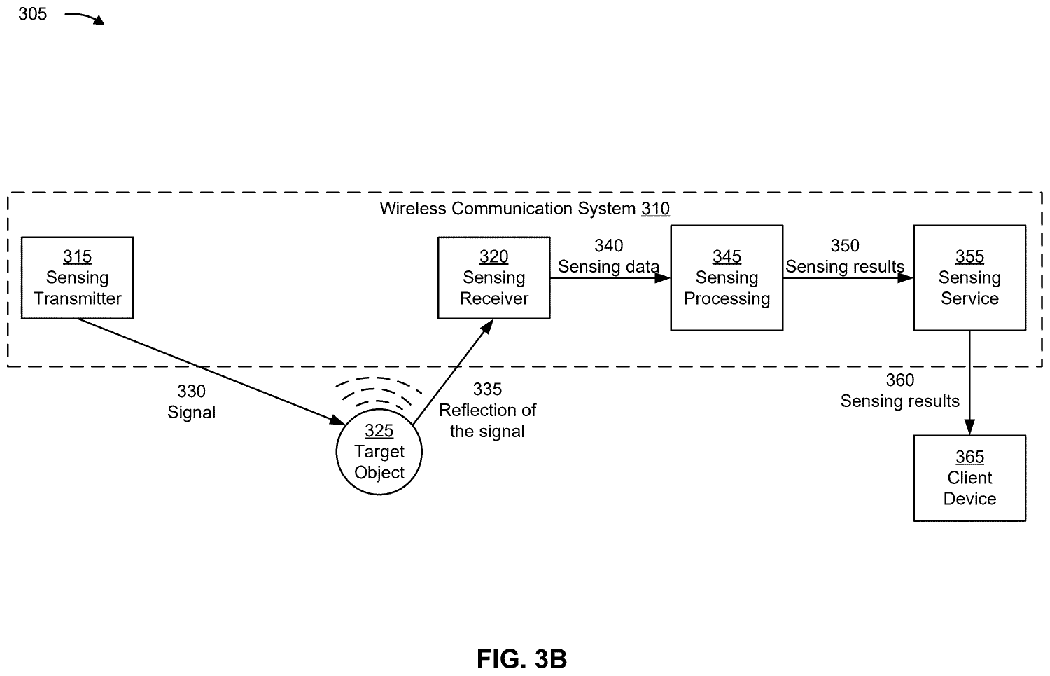

FIGS. 3A and 3B are diagrams illustrating examples of RF sensing, in accordance with the present disclosure. Wireless communication signals (e.g., RF signals configured to carry OFDM symbols) transmitted between a UE 120 and a network node 110 can be reused for RF sensing. Using wireless communication signals for RF sensing can be considered consumer-level radar with advanced detection capabilities that enable, among other things, touchless/device-free interaction with a device/system. “RF sensing” may be a radar operation performed by a wireless communication device, such as a UE, a network node, or another device (such as a wireless local area network (WLAN) access point or a TRP), using wireless communication signals.

RF sensing may also be referred to as environment sensing, radar sensing, WLAN sensing, Wi-Fi sensing, and/or wireless sensing, among other examples. The wireless communication signals used to perform RF sensing may be cellular communication signals (for example, LTE signals, NR signals, and/or 6G signals) or WLAN signals (for example, Wi-Fi signals), among other examples. As an example, the wireless communication signals may be an OFDM waveform as utilized in the wireless communication network 100. High-frequency communication signals, such as millimeter wave signals, may be beneficial to use as RF sensing signals because the higher frequency provides a more accurate range (for example, distance) detection and/or motion detection. As another example, WLAN signals (for example, WLAN or Wi-Fi signals that would otherwise be used for wireless communication) may be used to perform RF sensing (for example, to conserve power relative to using a higher frequency range signal). In such examples, the RF sensing may be referred to as WLAN sensing or Wi-Fi sensing.

RF sensing may be performed using various frequency bands or frequency ranges, such as the millimeter wave band or the sub-6 GHz band, among other examples. In some examples, different frequencies may be used sequentially (for example, first using a sub-6 GHz frequency and second using a millimeter wave frequency) by a wireless communication device performing the RF sensing to vary a resolution (for example, from coarse to fine), vary a detection range (for example, from large to narrow), and/or vary power consumption (for example, from low to high), among other examples.

As shown in FIGS. 3A and 3B, one or more wireless communication devices may detect and/or monitor a target object by transmitting and/or measuring wireless communication signals. FIG. 3A depicts an example of monostatic sensing 300. For example, the one or more wireless communication devices may be included in a wireless communication system 310, such as the wireless communication network 100. A sensing transmitter 315 and a sensing receiver 320 may communicate RF signals (for example, wireless communication signals) to perform RF sensing. In some examples, the sensing transmitter 315 and the sensing receiver 320 may be co-located, such as in a single wireless communication device (for example, as depicted in FIG. 3A). Examples where the sensing transmitter 315 and the sensing receiver 320 are co-located may be referred to as “monostatic sensing.” FIG. 3B depicts an example of bistatic sensing 305. For example, the sensing transmitter 315 and the sensing receiver 320 may not be co-located (for example, as depicted in FIG. 3B). For example, the sensing transmitter 315 and the sensing receiver 320 may be included in separate devices, such as in separate UEs or separate network nodes. Examples where the sensing transmitter 315 and the sensing receiver 320 are not co-located (for example, are included in different entities) may be referred to as “bistatic sensing.” In some examples, RF sensing may be associated with obtaining sensor data that is indicative of a characteristic of a target object 325. In some examples, an RF sensing operation may include multiple sensing transmitters 315 and/or multiple sensing receivers 320 (for example, referred to as “multistatic sensing”).

As shown in FIGS. 3A and 3B, the sensing transmitter 315 may transmit one or more signals 330. The one or more signals 330 may be RF signals, wireless communication signals, OFDM signals, and/or sensing reference signals, among other examples. The one or more signals may reflect off of the target object 325, resulting in a reflection 335 of the signal 330. The reflection 335 may be a reflection of a signal 330, a refraction of the signal 330, a diffraction of the signal 330, and/or a deflected version of the signal 330, among other examples. The sensing receiver 320 may receive and/or detect the reflection 335. The sensing receiver 320 may perform one or more measurements of the reflection 335 to obtain sensing data 340. The sensing data 340 may include information that is indicative of one or more characteristics of the target object 325. For example, the sensing data 340 may include a signal strength (for example, an RSRP), a received raw signal sample, a channel delay profile, one or more Doppler measurements (for example, Doppler per channel tap), a channel impulse response, a channel energy response, CSI, CQI, time delay measurements, and/or an angle of arrival (AoA) (for example, AoA per channel tap), among other examples.

As shown in FIGS. 3A and 3B, sensing processing 345 may be performed using the sensing data 340 to obtain sensing results 350. In some examples, a wireless communication device (for example, that includes the sensing receiver 320) may perform the sensing processing 345. In such examples, the wireless communication device may transmit, to a network node 110, the sensing results 350. In other examples, another device, such as a network node 110, may perform the sensing processing 345. In such examples, a wireless communication device (for example, that includes the sensing receiver 320) may transmit, and the network node 110 may receive, the sensing data 340. The sensing results 350 may include information for one or more characteristics of the target object 325. For example, the sensing results 350 may include positioning information, velocity information, a sensing resolution, object detection information, and/or other information that is determined using the sending data 340. The sensing results 350 may be provided to a sensing service 355 of the wireless communication system 310. The sensing service 355 may include one or more core network nodes or entities, such as one or more network nodes 110. The sensing service 355 may provide, to a client device 365, sensing results 360. The sensing results 360 may be the sensing results 350 or may be based on the sensing results 350. The client device 365 may be a server device or an application executing on a device. For example, the client device 365 may provide, to the sensing service 355, a sensing request. The sensing service 355 may configure, manage, and/or otherwise maintain a sensing operation (for example, in a similar manner as described herein) for fulfilling the sensing request.

Possible use cases of RF sensing include health monitoring (such as heartbeat detection, and/or respiration rate monitoring, among other examples), gesture recognition (such as human activity recognition, keystroke detection, and/or sign language recognition, among other examples), contextual information acquisition (such as location detection/tracking, direction finding, and/or range estimation, among other examples), and/or automotive radar (such as smart cruise control and/or collision avoidance), among other examples.

Similar to conventional radar (for example, frequency modulation continuous waveform (FMCW) radar), a signal 330 can be used to estimate the range (for example, distance), velocity (for example, Doppler spread), and/or angle (for example, AoA) of the target object 325. Unlike conventional radar, RF sensing may use a physical (PHY) layer for both RF sensing measurements and wireless communication. Signals 330 may be transmitted in a beam (for example, using beamforming) and may reflect off nearby objects within the beam. A portion of the transmitted RF signals is reflected back toward a sensing receiver 320, which the reflection 335 (for example, via the reflections of the transmitted signals).

In some examples, an OFDM waveform can be used for both wireless communication (for example, over a wireless network) and RF sensing. To use an OFDM waveform as a signal for RF sensing, specific reference signals, which may be referred to herein as sensing reference signals, may be needed. The RF sensing performance (for example, resolution and maximum values of range, velocity, and/or angle) may depend on the sensing reference signal design. For example, for a gesture recognition use case, coarse range/velocity estimation may be sufficient for the RF sensing. That is, it may be sufficient for a wireless communication device to be able to detect a pattern of movement relative to the current position of the target object 325 (for example, a user's hand or head). In such examples, a low density (for example, sparse) sensing reference signal with a short wavelength and narrow bandwidth may be sufficient to provide the necessary range and velocity resolution. For a vibration detection use case, such as for respiration monitoring, accurate Doppler estimation may be important, whereas accurate range estimation may not be as important. In such examples, a high-density sensing reference signal with a long duration in the time domain may be beneficial. For a location detection use case, such as for object detection, accurate range estimation may be important, whereas accurate Doppler estimation may not be as important. In such examples, a high-density wideband sensing reference signal in the frequency domain may be beneficial. Therefore, a network entity may configure one or more sensing reference signals depending on a use case of the RF sensing to improve the RF sensing performance. In some examples, a sensing reference signal may be a sounding reference signal (SRS), a wireless communication reference signal, or a WLAN signal, among other examples.

As indicated above, FIGS. 3A and 3B are provided as examples. Other examples may differ from what is described with respect to FIGS. 3A and 3B.

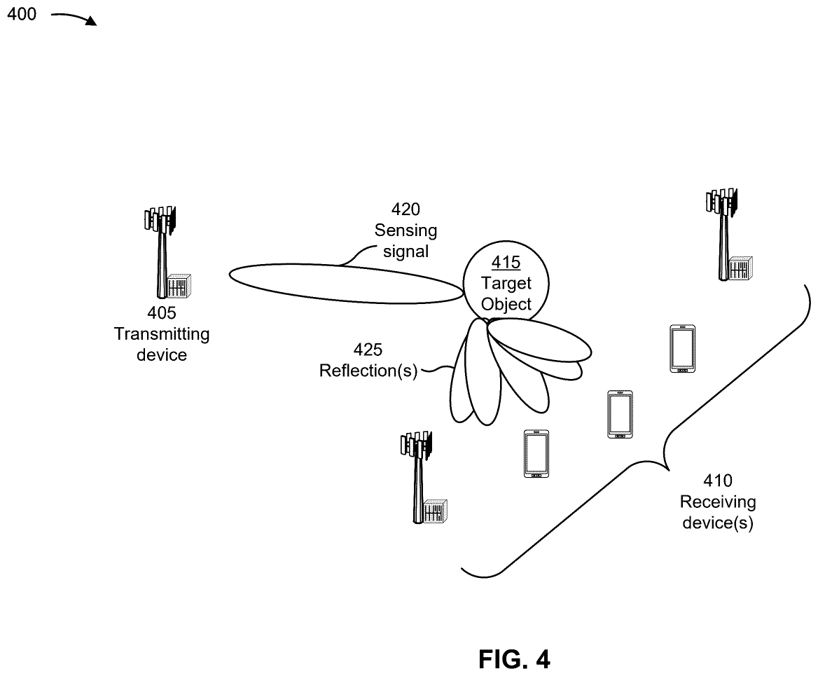

FIG. 4 is a diagram illustrating an example 400 associated with multi-static cooperative RF sensing, in accordance with the present disclosure. As shown in FIG. 4, example 400 includes a transmitting device 405 and one or more receiving devices 410. The transmitting device 405 may be, or may include, the sensing transmitter 315. In some aspects, the transmitting device 405 may be a network node 110, a UE 120, or another wireless communication device. The one or more receiving devices 410 may be, or may include, the sensing receiver 320. In some aspects, the one or more receiving devices 410 may include a UE, a network node, or another wireless communication device. In some aspects, the transmitting device 405 and the one or more receiving devices 410 may be included in a wireless network, such as the wireless communication network 100.

As shown in FIG. 4, the transmitting device 405 and the one or more receiving devices 410 may perform RF sensing to obtain localization information for a target object 415. The target object 415 may be a device-free object (e.g., may be an object that does not include a device that is capable of communicating with the transmitting device 405 and the one or more receiving devices 410 or via the wireless communication network 100). The localization information may include an object detection indicator (e.g., indicating whether the target object 415 is detected), and/or an indication of a location of the target object 415 (e.g., geographic coordinates of the target object 415). For example, the RF sensing depicted in FIG. 4 may be cooperative multistatic sensing in which multiple receiving devices 410 obtain sensing data used to obtain or determine the localization information for the target object 415.

For example, the transmitting device 405 may transmit a sensing signal 420 (e.g., in a similar manner as described in connection with FIGS. 3A and 3B). The sensing signal 420 may reflect, deflect, refract, or otherwise redirect off of the target object 415 (e.g., as shown by the one or more reflections 425). The one or more receiving devices 410 may perform one or more measurements of the reflection(s) 425 to obtain sensing data. The sensing data may include information that is indicative of one or more characteristics of the target object 415. For example, the sensing data may include a signal strength (for example, an RSRP), a received raw signal sample, a channel delay profile, one or more Doppler measurements (for example, Doppler per channel tap), a channel impulse response, a channel energy response, CSI, CQI, time delay measurements, and/or an angle of arrival (AoA) (for example, AoA per channel tap), among other examples. In some aspects, the one or more receiving devices 410 may transmit the sensing data to the transmitting device 405 or another device for processing.

For example, a network node 110 (e.g., a base station, the transmitting device 405, or a network server device) may perform processing of sensing data collected from the one or more receiving devices 410. The network node 110 may receive position data of the one or more receiving devices 410 (e.g., from a positioning operation with a UE or from a known position of a network node or TRP). The network node 110 may determine the localization information for the target object 415 using the collected sensing data, the position of the transmitting device 405, and the positions of respective receiving devices 410.

As indicated above, FIG. 4 is provided as an example. Other examples may differ from what is described with respect to FIG. 4.

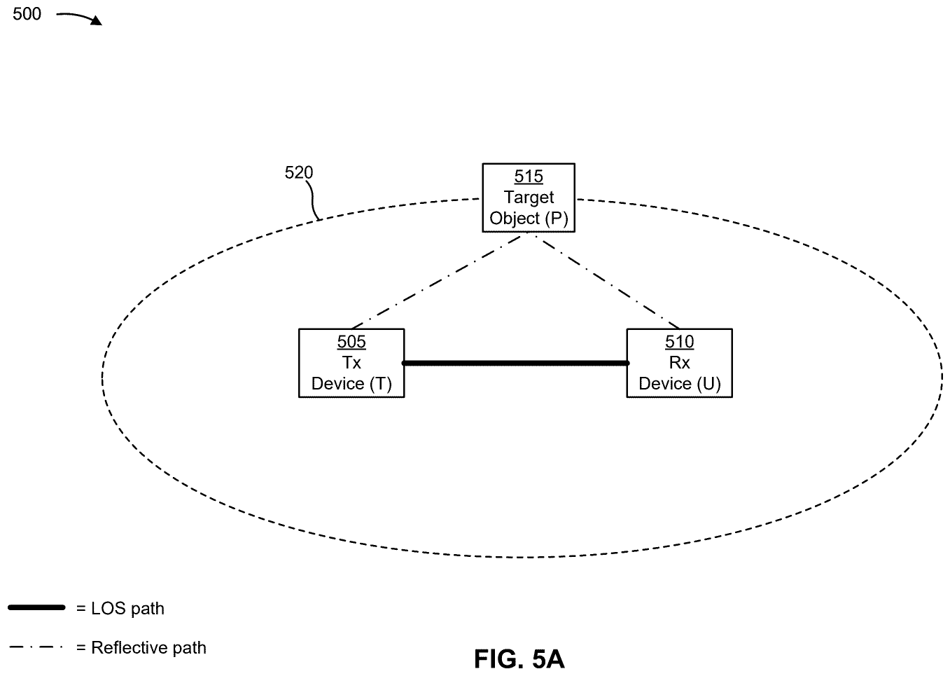

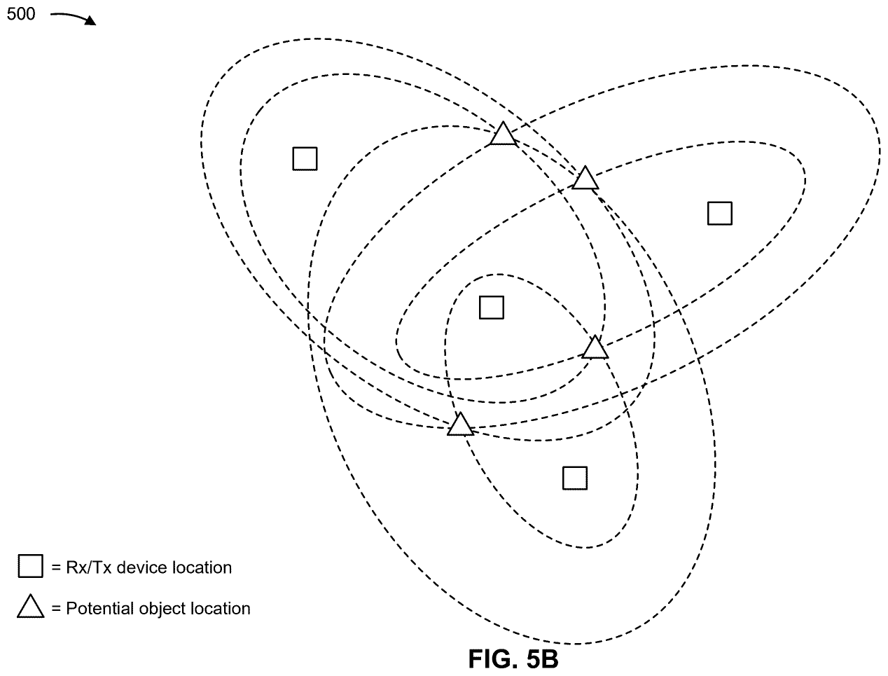

FIGS. 5A and 5B are diagrams illustrating an example 500 of object localization using multi-static cooperative RF sensing, in accordance with the present disclosure. Example 500 includes a transmitting device 505 and one or more receiving devices 510 (e.g., a single receiving device 510 in FIG. 5A). The transmitting device 505 may be, or may include, the sensing transmitter 315 or the transmitting device 405. In some aspects, the transmitting device 505 may be a network node 110, a UE 120, or another wireless communication device. The one or more receiving devices 510 may be, or may include, the sensing receiver 320 or a receiving device 410. In some aspects, the one or more receiving devices 510 may include a UE, a network node, or another wireless communication device. In some aspects, the transmitting device 505 and the one or more receiving devices 510 may be included in a wireless network, such as the wireless communication network 100.

In some examples, a time of flight (ToF) analysis may be used to determine localization information for a target object 515. For example, there may be a line of sight (LOS) path between the transmitting device 505 and a receiving device 510. For example, the LOS path may be a path associated with a signal that travels directly from the transmitting device 505 to the receiving device 510. Additionally, there may be one or more reflective paths between the transmitting device 505 and a receiving device 510. For example, there may be a reflective path that is associated with a signal that is transmitted by the transmitting device 505 and is reflected or otherwise redirected by the target object 515 toward the receiving device 510. FIG. 5A shows an example where the reflective path is a one-hop path (e.g., in which a signal transmitted via the reflective path reflects off a single object, such as the target object 515). The reflective path may also be referred to as a non-LOS (NLOS) path.

In some examples, the receiving device 510 may measure a CIR associated with the transmitting device 505. A CIR may be an iFFT of an observed channel frequency response (e.g., within a band or bandwidth). For example, the CIR may be the iFFT of an observed bandlimited channel frequency response. A channel tap (or sample) l of the CIR may be represented as

$${h}_{l} = \frac{1}{N} {\sum }_{k = 0}^{N - 1} {H}_{k} {e}^{\frac{j 2 π kl}{N}} ,$$

where N is a total quantity of observed frequency domain samples from the channel frequency response (or equivalently total quantity of taps observed in the CIR in the time domain), k is a subcarrier index ranging from 0 to N−1, Hₖ is a channel frequency response (CFR) observed at a frequency index (e.g., a subcarrier) k (e.g., Hₖ is a complex amplitude of the channel frequency response at the discrete subcarrier index k), and e^{j2πkl/N} is a complex exponential function associated with converting the CFR in frequency domain to the CIR in the time (or more precisely “delay”) domain (e.g., where j is an imaginary unit). A discrete time domain representation of the CIR (at a delay n) may be hₙ=Σₗ₌₀^{N-1}hₗδ(n−l), where hₙ is the value of the CIR at a discrete delay index n, N is the total quantity of samples (or taps) in the CIR, l is a summation index to represent a delay (or tap) index in the CIR, and δ(n−l) is a delta function (e.g., a Kronecker delta function) to represent a delay or time shift between the input and output of the CIR. A CER denoted by pₙ may be the energy of the CIR, i.e. pₙ=|hₙ|² (e.g., taps of the CER correspond to the energy of respective taps of the CIR). The CER may be composed of squared magnitudes of the CIR taps at different delays. For example, a tap (or sample) n of the CER may be represented as pₙ=Σₗ₌₀^{N-1}|hₗ|²δ(n−l), where pₙ is a value of the CER at a delay index n.

The receiving device 510 may measure a CIR for the transmitting device 505 over time. From the measured CIR, the receiving device 510 may determine a ToF for different paths of a signal (e.g., a sensing signal) transmitted by the transmitting device 505. For example, a distance associated with the LOS path may be c×tₗₒₛ, where c is a constant (the speed of light) and tₗₒₛ is the ToF for the LOS path. A distance associated with the reflective path may be c×tₚₐₜₕ, where tₚₐₜₕ is the ToF for the reflective path. Therefore, a position of the target object 515 may be estimated from the following equation: TP+PU−TU=c×(tₚₐₜₕ−tₗₒₛ), where TU is a distance associated with the LOS path, PU is a distance between the target object 515 and the receiving device 510, and TP is a distance between the target object 515 and the transmitting device 505. The position of the transmitting device 505 and the position of the receiving device 510 may be known and/or static. Additionally, the right side of the equation (e.g., c×(tₚₐₜₕ−tₗₒₛ)) may be constant. As a result, the equation may define an ellipse 520 on which a position of the target object 515 may be located. The ellipse 520 may have focal points that correspond to the position of the transmitting device 505 and the position of the receiving device 510. In other words, using the measured CER, a device may determine that the target object 515 is located somewhere on the ellipse 520 having focal points that correspond to the transmitting device 505 position and the receiving device 510 location.

As shown in FIG. 5B, using cooperative multi-static RF sensing, CERs measured by multiple devices (e.g., multiple receiving devices 510) may be obtained to indicate multiple ellipses defining potential locations of target object(s) 515 in an environment. As shown in FIG. 5B, an intersection between two or more ellipses may be indicative of a potential object (e.g., target object 515) location. Therefore, using CIRs and/or CERs measured by receiving devices 510 (e.g., UEs) of different transmitting devices 505 (e.g., TRPs or network nodes 110) in a cooperative multi-static RF sensing scenario, a device (e.g., a network node 110 and/or a network server) may determine potential locations of target object(s) 515 in an environment.

However, there are many challenges with accurately obtaining localization information for target objects of interest in a dynamic environment. For example, a target object may be static in the environment. It may be difficult to distinguish between the target object and other static objects in the environment, such as trees, buildings, or other objects that may be permanent fixtures in the environment. Therefore, Doppler information and/or CIR information alone may be insufficient for obtaining the localization information for target objects of interest in the environment. As another example, the quantity of target objects in the environment may be dynamic and may change over time. As a result, there may be a dynamic quantity of outputs for localization information for target objects of interest in a dynamic environment, increasing the complexity of identifying target objects and determining the localization information for the target objects.

As another example, there may be a dynamic quantity of receiving devices in the environment. For example, the quantity of receiving devices (e.g., UEs) participating in the cooperative multi-static RF sensing operation may change over time. As a result, there may be a dynamic quantity of CER and/or CIR inputs for localization information for target objects of interest in the dynamic environment. The dynamic quantity of inputs may increase the complexity of identifying target objects and determining the localization information for the target objects. Further, a location of the receiving devices may be dynamic and may change over time. For example, the receiving devices may be mobile devices that move throughout the environment over time. As a result, the relationship between CIR taps and target object localization information may change over time. Additionally, the same CIRs may result in different localization information over time because the receiving device may be moving over time.

As indicated above, FIGS. 5A and 5B are provided as examples. Other examples may differ from what is described with respect to FIGS. 5A and 5B.

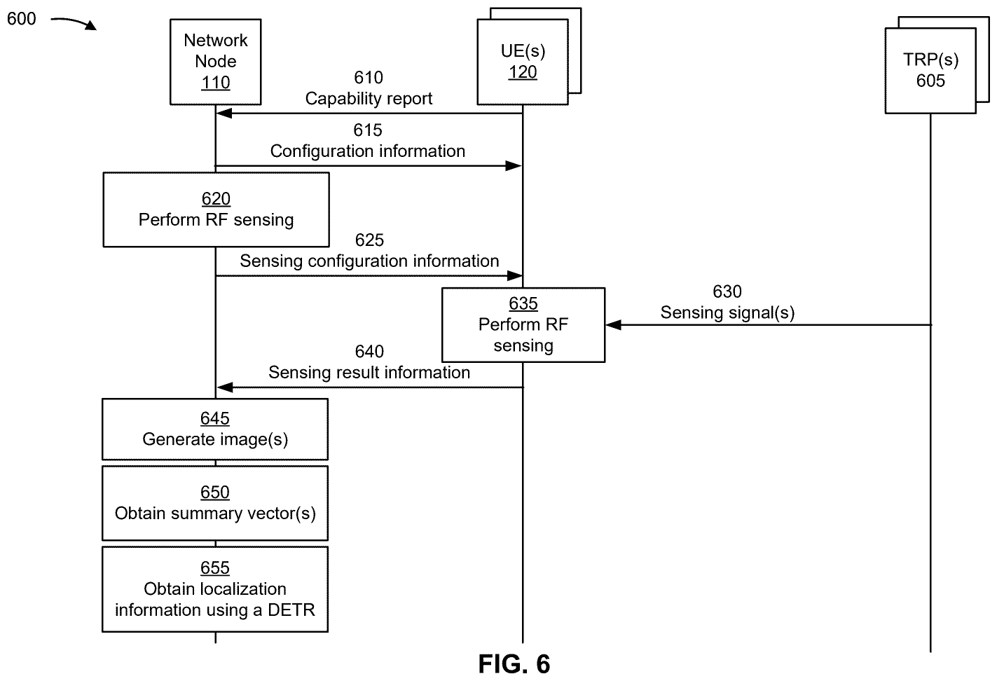

FIG. 6 is a diagram of an example 600 associated with object localization using RF sensing and computer vision, in accordance with the present disclosure. As shown in FIG. 6, a network node 110 (e.g., a base station, a network server, a CU, a DU, and/or an RU) may communicate with one or more UEs 120. In some aspects, the network node 110 and the UE(s) 120 may be part of a wireless network (e.g., the wireless communication network 100). The UE(s) 120 and the network node 110 may have established a wireless connection prior to operations shown in FIG. 6. The UE(s) 120 and/or the network node 110 may communicate with one or more TRPs 605. The TRP(s) 605 may be transmitting devices for RF sensing, as described in more detail elsewhere herein.

In some aspects, as shown by reference number 610, the UE 120 may transmit, and the network node 110 may receive, a capability report. The UE 120 may transmit the capability report via an uplink communication, a UE assistance information (UAI) communication, an uplink control information (UCI) communication, an uplink MAC control element (MAC-CE) communication, an RRC communication, a physical uplink control channel (PUCCH), and/or a physical uplink shared channel (PUSCH), among other examples. The capability report may indicate one or more parameters associated with respective capabilities of the UE 120. The one or more parameters may be indicated via respective information elements (IEs) included in the capability report.

The capability report may indicate whether the UE supports a feature and/or one or more parameters related to the feature. For example, the capability report may indicate a capability and/or parameter for performing RF sensing. As another example, the capability report may indicate a capability and/or parameter for generating one or more images (e.g., that are representative of CERs obtained by the UE 120) and/or reporting summary vectors of respective images. One or more operations described herein may be based on capability information of the capabilities report. For example, the UE may perform a communication in accordance with the capability information, or may receive configuration information that is in accordance with the capability information. In some aspects, the capability report may indicate UE support for performing RF sensing in a similar manner as described herein. In some aspects, the capability report may indicate whether the UE 120 supports generating images using CERs obtained via an RF sensing operation (e.g., via CIRs measured from signals transmitted via respective TRPs 605). In some aspects, the capability report may indicate whether the UE 120 supports transmitting an indication of summary vectors for respective images that are representative of CERs, as described in more detail elsewhere herein.

In some aspects, as shown by reference number 615, the network node may transmit, and the UE may receive, configuration information. In some aspects, the UE may receive the configuration information via one or more of system information (e.g., a master information block (MIB) and/or a system information block (SIB)), RRC signaling, MAC signaling (e.g., one or more MAC-CEs), and/or downlink control information (DCI), among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (e.g., an indication described herein) may include a dynamic indication, such as one or more MAC-CEs and/or one or more DCI messages, among other examples.

In some aspects, the configuration information may indicate that the UE 120 is to perform RF sensing, as described in more detail elsewhere herein. For example, the configuration information may indicate that the UE 120 is to transmit sensing result information for an RF sensing operation. The sensing result information may be associated with one or more images that are representative of CERs for respective TRPs 605. The sensing result information may be associated with the one or more images in that the sensing result information may include the CERs that are used to generate the one or more images (e.g., by the network node 110, as described in more detail elsewhere herein).

The UE 120 may configure itself based at least in part on the configuration information. In some aspects, the UE 120 may be configured to perform one or more operations described herein based at least in part on the configuration information.

In some aspects, the configuration information described in connection with reference number 615 and/or the capability report described in connection with reference number 610 may include information transmitted via multiple communications. Additionally, or alternatively, the network node 110 may transmit the configuration information, or a communication including at least a portion of the configuration information, before and/or after the UE 120 transmits the capability report. For example, the network node 110 may transmit a first portion of the configuration information before the UE 120 transmits the capability report, the UE 120 may transmit at least a portion of the capability report, and the network node 110 may transmit a second portion of the configuration information after receiving at least the portion of the capability report.

As shown by reference number 620, the network node 110 may perform RF sensing to obtain information associated with an environment. For example, the network node 110 may perform RF sensing of an area. In some aspects, the RF sensing (e.g., results of the RF sensing) may indicate a zone of interest for the area. The RF sensing performed by the network node 110 may be monostatic RF sensing. For example, the network node 110 may perform monostatic RF sensing to obtain information associated with the area. As an example, the RF sensing results may indicate general (or rough) locations or detections of objects in the environment. The network node 110 may determine that the zone of interest is area(s) in which the objects are detected (e.g., via monostatic RF sensing) in the environment.

The network node 110 may select one or more UEs 120 for a cooperative multistatic RF sensing operation. In some aspects, the network node 110 may select the one or more UEs based on, in response to, or otherwise associated with the RF sensing performed by the network node 110. For example, the network node 110 may select one or more UEs 120 that are located in (or near) the zone of interest (e.g., and that are capable of performing RF sensing). For example, the network node 110 may obtain positioning information for the one or more UEs 120 (e.g., indicating locations of respective UEs 120). The network node 110 may select the one or more UEs 120 based on, or otherwise associated with, the one or more UEs 120 being located in a position that enables the UEs 120 to perform RF sensing of the zone of interest.

The network node 110 may identify one or more TRPs 605 for the cooperative multistatic RF sensing operation. The one or more TRPs 605 may be transmitting devices for the cooperative multistatic RF sensing operation. The network node 110 may select the one or more TRPs 605 based on the one or more TRPs 605 being capable of transmitting in a spatial direction toward the zone of interest. Additionally, the network node 110 may select the one or more TRPs 605 based on the one or more TRPs 605 being located in, or near, the zone of interest.

The network node 110 may configure the one or more TRPs 605 to transmit sensing signals in a spatial direction toward the zone of interest. By performing the RF sensing (e.g., the monostatic RF sensing), the network node 110 may configure the one or more TRPs 605 to transmit sensing signals only in spatial direction(s) toward the zone of interest. This may reduce a quantity of beams used by the TRP(s) 605 to transmit the sensing signals. As a result, the one or more TRPs 605 may conserve network resources, processing resources, and/or power resources (e.g., energy resources), among other examples, that would have otherwise been associated with transmitting the sensing signal(s) in spatial direction that are not toward the zone of interest.

As shown by reference number 625, the network node 110 may transmit, and the UE(s) 120 may receive, sensing configuration information. The network node 110 may transmit the sensing configuration information in a similar manner as described in connection with the configuration information (and reference number 615). In some aspects, the sensing configuration information may indicate the one or more TRPs 605 from which the UE(s) 120 are to measure sensing signals for the cooperative multistatic RF sensing operation. In some aspects, the sensing configuration information may be transmitted by the one or more TRP(s) 605. For example, each TRP 605 may configure the UE(s) 120 with sensing signal resources to be measured by the UE(s) 120.

For example, the sensing configuration information may include sensing signal resource configurations for respective TRPs 605 of the TRP(s) 605 selected for the cooperative multistatic RF sensing operation. The sensing configuration information may indicate resources (e.g., time domain resources, frequency domain resources, and/or spatial domain resources) of sensing signals to be transmitted by respective TRPs 605. For example, the sensing configuration information may configure the UE(s) 120 to measure the configured resources of sensing signals (e.g., to obtain CIR(s) and/or CER(s) for respective TRPs 605).

As shown by reference number 630, the one or more TRPs 605 may transmit respective sensing signals (e.g., as configured by the sensing configuration information). As shown by reference number 635, the UE(s) 120 may perform RF sensing (e.g., by measuring the sensing signal(s) over time). For example, the UE(s) 120 may obtain, via one or more RF sensing measurements of the one or more TRPs 605, sensing measurement information (e.g., sensing data, as described elsewhere herein). The sensing measurement information may include information that is indicative of one or more characteristics of target objects in the zone of interest.

In some aspects, the sensing measurement information may include CERs for respective TRPs 605. For example, the UE(s) 120 may measure CIRs for the respective TRPs via measurement(s) of the sensing signals transmitted by the respective TRPs 605. The UE(s) 120 may obtain CERs for the respective TRPs 605 using the measured CIRs. For example, for a given UE 120 and a given TRP 605, the given UE 120 may measure or obtain one or more CIR taps or samples (e.g., over time). The CER for the given TRP 605 may include the CIR taps for the given TRP 605 as measured by the given UE 120. For example, the UE 120 may compute the CER from the CIRs measured via transmit (Tx) beam and receive (Rx) beam pairs of the given TRP 605. The given UE 120 may sum CERs from the Tx beam and Rx beam pairs. The UE 120 may determine an average CER for the given TRP 605 using the summed CERs for all Tx beam and Rx beam pairs of the given TRP 605. This may reduce a dimensionality of the CER data used as described elsewhere herein, thereby reducing a complexity of other operations described herein. The given UE 120 may obtain an average CER for each TRP 605 of the one or more TRPs in a similar manner. Additionally, each UE 120 (e.g., of the one or more UEs 120 selected for the cooperative multistatic RF sensing operation) may obtain CER data (e.g., average CERs) for each TRP 605 of the one or more TRPs in a similar manner.

As shown by reference number 640, the UE(s) 120 may transmit, and the network node 110 may receive, sensing result information. The sensing result information may be associated with one or more images that are representative of CERs for respective TRPs 605. For example, the sensing result information may be associated with the one or more images in that the sensing result information may be used by the network node 110 to generate the one or more images, as described elsewhere herein. The sensing result information may include the sensing measurement information. For example, the sensing result information may include the CERs (e.g., the average CERs for each TRP 605) obtained and/or measured by a given UE 120. In other words, the UEs 120 may report, to the network node 110, the average CER for each TRP 605 of the one or more TRPs 605 selected for the cooperative multistatic RF sensing operation.

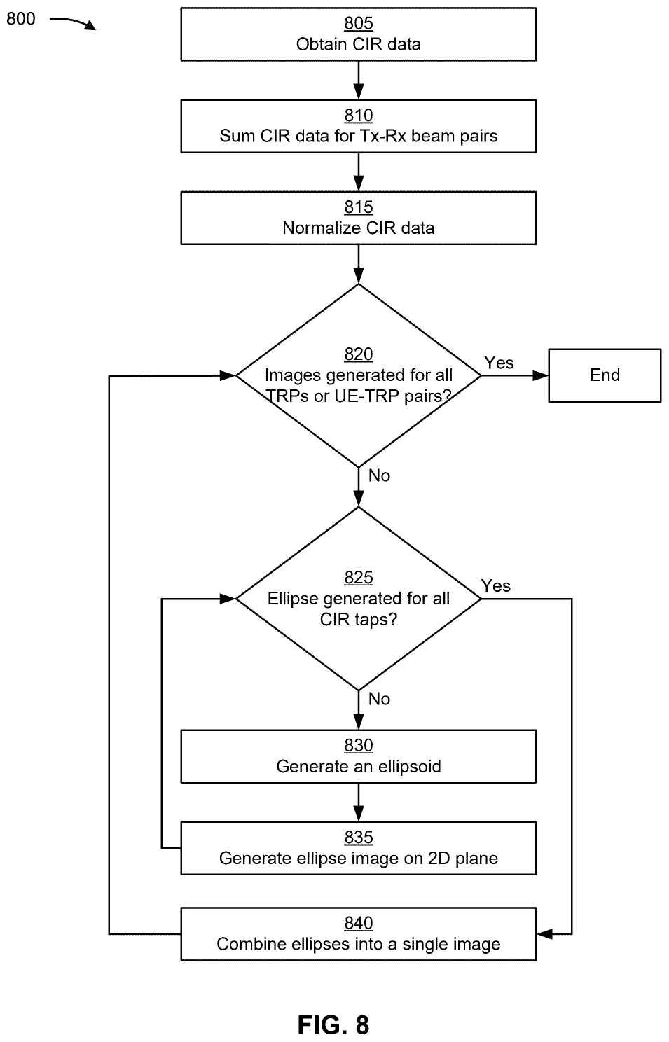

The network node 110 may perform one or more visualization operations using the sensing result information. The one or more visualization operations are depicted and described in more detail in connection with FIG. 8. As an example, as shown by reference number 645, the network node 110 may generate one or more images that are representative of the CERs reported by the UEs 120. The network node 110 may obtain the one or more images using the sensing result information.

For example, the network node 110 may generate, for each UE-TRP pair from the one or more TRPs 605 and the one or more UEs 120, a CER image that includes one or more ellipses for respective channel taps of a CER for that UE-TRP pair as indicated by the sensing result information. For example, the network node 110 may determine or identify one or more UE-TRP pairs from the one or more UEs 120 and the one or more TRPs 605 selected for the cooperative multistatic RF sensing operation. From the CER of each UE-TRP pair, the network node 110 may generate an ellipsoid for each tap (or samples) of the CER (e.g., in the delay domain). For example, as described elsewhere herein, a CER tap (or sample) may be represented as an ellipsoid in the three-dimensional (3D) space. The network node 110 may generate a CER image for a given UE-TRP pair by projecting the ellipsoid(s) (e.g., representing the CER taps for the CER of the given UE-TRP pair) on a two-dimensional (2D) plane at a height of interest indicated by the RF sensing (e.g., performed by the network node 110 as described in connection with reference number 620). As a result, a CER measured for a UE-TRP pair may be converted to a CER image that contains ellipses (e.g., one ellipse for each channel tap of the CER).

The height of interest may be a height at which target objects are expected to be located in the zone of interest. The network node 110 may determine the height of interest based on performing the monostatic RF sensing of the area that includes the zone of interest, as described elsewhere herein. In some aspects, the height of interest may be ground level (e.g., a height at which the ground or floor is located). For example, target objects in the zone of interest may be expected to be located at ground level (e.g., on the ground or floor). In some aspects, the network node 110 may transmit, and the UE(s) 120 may receive, an indication of the height of interest (e.g., in the configuration information or the sensing configuration information).

The network node 110 may generate CER images for each UE-TRP pair in a similar manner. For example, the network node 110 may generate a set of ellipses for each UE-TRP pair (e.g., in a CER image). As an example, if there are T TRPs 605 and L UEs 120, then the network node 110 may generate L images for a given TRP (e.g., one image for each UE 120 and a given TRP). The process may be repeated for each TRP 605, resulting in a total of (T×L) images (e.g., if there are four TRPs 605 and nine UEs 120, then the network node 110 may generate 36 CER images).

As described elsewhere herein, a potential location of a target object may be indicated via intersections of two or more ellipses from the CER images. Therefore, the network node 110 may combine two or more CER images to represent the potential locations of target objects in the zone of interest (e.g., via intersections between two or more ellipses in a combined image). In some aspects, the network node 110 may combine all CER images to form a combined image (e.g., a single combined image). In other aspects, the network node 110 may generate combined images for two or more TRPs 605. For example, the network node 110 may generate multiple summed or combined images using CER images for two or more TRPs 605. This may reduce a complexity and processing overhead that may have otherwise been associated with combining all of the CER images into a single combined image. For example, combining all CER images into a single image may result in a complicated image with many patterns to be processed to obtain localization information for target objects. Using less than all TRPs to generate a combined image may result in a less complicated image, thereby reducing the complexity and processing overhead associated with obtaining the localization information, as described elsewhere herein.

For example, the network node 110 may generate all possible TRP pairs from the one or more TRPs 605. For example, if the one or more TRPs 605 include a TRP 1, a TRP 2, a TRP 3, and a TRP 4, then the TRP pairs may include {TRP 1, TRP 2}, {TRP 1, TRP 3}, {TRP 1, TRP 4}, {TRP 2, TRP 3}, {TRP 2, TRP 4}, and {TRP 3, TRP 4}. The network node 110 may generate summed or combined images for each TRP pair using CER image(s) associated with TRPs included in the TRP pair. For example, the network node 110 may generate, for each TRP pair, an image that is a summed image of a first CER image associated with a first TRP 605 included in that TRP pair and a second CER image associated with a second TRP 605 included in that TRP pair. For example, for each UE 120, the network node 110 may generate combined images for each TRP pair. As an example, if there are four TRPs 605 (e.g., resulting in six possible TRP pairs) and nine UEs 120, then the network node 110 may generate 54 combined images (e.g., six combined images for each UE 120, one for each TRP pair).

As shown by reference number 650, the network node 110 may obtain summary vectors for respective images. In some aspects, the network node 110 may obtain summary vectors for respective combined images (e.g., generated by the network node 110 as described in connection with reference number 645). The network node 110 may obtain the summary vectors via a vision transformer. A vision transformer may be a model for image classification that uses a transformer architecture over patches of an image. A vision transformer may include a neural network architecture, such as a convolutional neural network (CNN).

For example, an image (e.g., a combined image representative of CERs for two or more TRPs and a given UE 120) may be an input to the vision transformer. The image may be divided into a set of patches. Each patch may be projected by a linear layer into a vector. In some aspects, the vision transformer may include positional encoding that encodes an order of the patches (e.g., by adding an additional learnable vector having the same dimension as the vectors of the patches). The network node 110 may prepend a trainable embedding token vector before the patch vectors. The embedding token vector may be a classification token used to represent the entire input sequence of vectors. For example, the embedding token vector may be used to represent the entire image. The embedding token vector may be similar to a classification (CLS) token for a bidirectional encoder representations from transformers (BERT) model. The vectors may be provided as an input to a transformer encoder included in the vision transformer. In some aspects, the inputs to the vision transformer may be obtained via convolutional layers with strides.

The summary vector may be an output vector for the image corresponding to the embedding token vector. For example, each output vector of the transformer encoder may include context information from all other inputs. Therefore, the first output vector may serve as a “summary” of the image input to the vision transformer. The network node 110 may obtain summary vectors for each image (e.g., each combined image) in a similar manner. The summary vectors may also be referred to as summary embeddings.

As shown by reference number 655, the network node 110 may obtain localization information using a DETR model. The localization information may indicate information for one or more objects (e.g., target objects) in the zone of interest. The network node 110 may obtain the localization information using the summary vectors of the sensing result information. For example, the network node 110 may obtain the localization information using the summary vectors of images (e.g., combined images) that are representative of CERs measured by UE(s) 120, as described in more detail elsewhere herein.

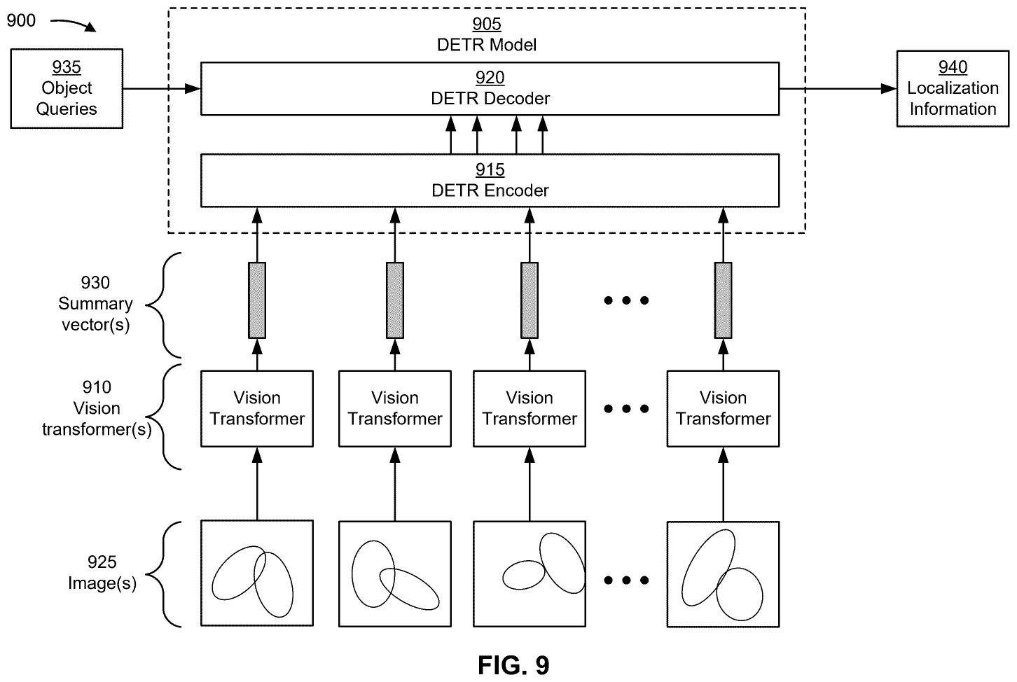

For example, the network node 110 may provide, as an input to the DETR model (e.g., to an encoder of the DETR model), the one or more summary vectors. The encoder of the DETR model may output one or more output vectors. The network node 110 may provide, as an input to a decoder of the DETR model, the one or more output vectors and one or more object queries. The one or more object queries may be queries for localization information for respective potential target objects. The decoder of the DETR model may output localization information for each object query. For example, the network node 110 may use DETR decoder output vectors to compute the coordinate locations of the targets and/or a probability of whether a target object is present or absent, among other examples. For example, the localization information may include an indication of probability information indicating a likelihood that the one or more objects are present in the zone of interest. Additionally, the localization information may include an indication of coordinate locations for respective objects of the one or more objects. The DETR model architecture is depicted and described in more detail in connection with FIG. 9.

As indicated above, FIG. 6 is provided as an example. Other examples may differ from what is described with respect to FIG. 6.

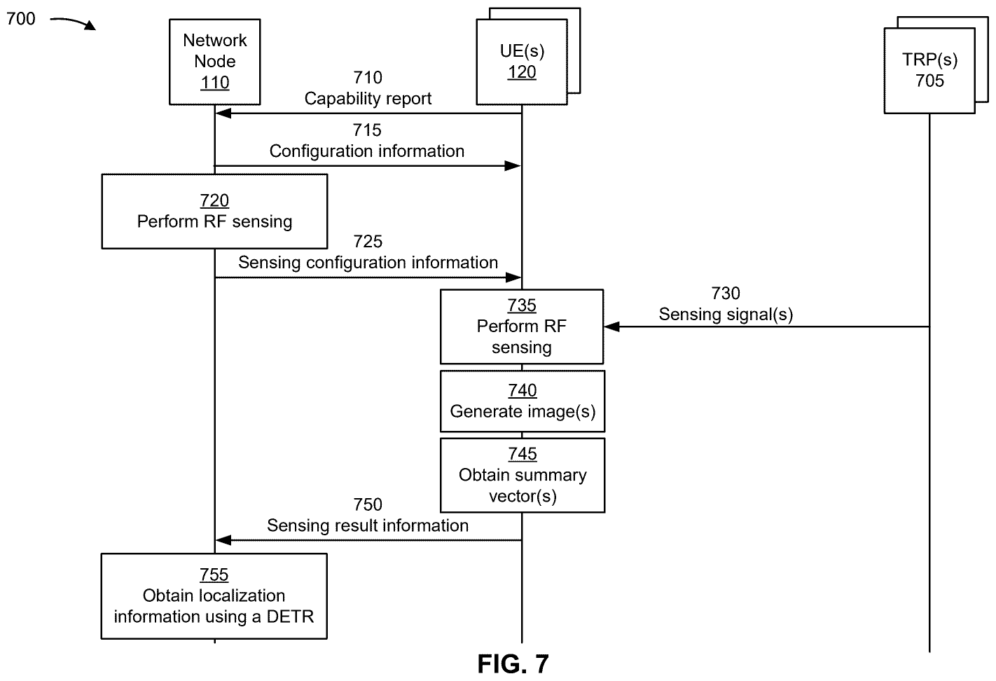

FIG. 7 is a diagram of an example 700 associated with object localization using RF sensing and computer vision, in accordance with the present disclosure. As shown in FIG. 7, a network node 110 (e.g., a base station, a network server, a CU, a DU, and/or an RU) may communicate with one or more UEs 120. In some aspects, the network node 110 and the UE(s) 120 may be part of a wireless network (e.g., the wireless communication network 100). The UE(s) 120 and the network node 110 may have established a wireless connection prior to operations shown in FIG. 7. The UE(s) 120 and/or the network node 110 may communicate with one or more TRPs 705. The TRP(s) 705 may be transmitting devices for RF sensing, as described in more detail elsewhere herein.

In some aspects, as shown by reference number 710, the UE 120 may transmit, and the network node 110 may receive, a capability report. The UE 120 may transmit the capability report in a similar manner as described in connection with FIG. 6 and reference number 610. In some aspects, as shown by reference number 715, the network node may transmit, and the UE may receive, configuration information. The configuration information may be similar to the configuration information described in connection with FIG. 6 and reference number 615.

The UE 120 may configure itself based at least in part on the configuration information. In some aspects, the UE 120 may be configured to perform one or more operations described herein based at least in part on the configuration information. In some aspects, the configuration information described in connection with reference number 715 and/or the capability report described in connection with reference number 710 may include information transmitted via multiple communications. Additionally, or alternatively, the network node 110 may transmit the configuration information, or a communication including at least a portion of the configuration information, before and/or after the UE 120 transmits the capability report. For example, the network node 110 may transmit a first portion of the configuration information before the UE 120 transmits the capability report, the UE 120 may transmit at least a portion of the capability report, and the network node 110 may transmit a second portion of the configuration information after receiving at least the portion of the capability report.

As shown by reference number 720, the network node 110 may perform RF sensing to obtain information associated with an environment. For example, the network node 110 may perform RF sensing of an area in a similar manner as described in connection with FIG. 6 and reference number 620.

As shown by reference number 725, the network node 110 may transmit, and the UE(s) 120 may receive, sensing configuration information. The network node 110 may transmit the sensing configuration information in a similar manner as described in connection with the configuration information (and reference number 715). In some aspects, the sensing configuration information may indicate the one or more TRPs 705 from which the UE(s) 120 are to measure sensing signals for the cooperative multistatic RF sensing operation. In some aspects, the sensing configuration information may be transmitted by the one or more TRP(s) 705. For example, each TRP 705 may configure the UE(s) 120 with sensing signal resources to be measured by the UE(s) 120.

For example, the sensing configuration information may include sensing signal resource configurations for respective TRPs 705 of the TRP(s) 705 selected for the cooperative multistatic RF sensing operation. The sensing configuration information may indicate resources (e.g., time domain resources, frequency domain resources, and/or spatial domain resources) of sensing signals to be transmitted by respective TRPs 705. For example, the sensing configuration information may configure the UE(s) 120 to measure the configured resources of sensing signals (e.g., to obtain CIR(s) and/or CER(s) for respective TRPs 705).

As shown by reference number 730, the one or more TRPs 705 may transmit respective sensing signals (e.g., as configured by the sensing configuration information). As shown by reference number 735, the UE(s) 120 may perform RF sensing (e.g., by measuring the sensing signal(s) over time). For example, the UE(s) 120 may obtain, via one or more RF sensing measurements of the one or more TRPs 705, sensing measurement information (e.g., sensing data, as described elsewhere herein). The sensing measurement information may include information that is indicative of one or more characteristics of target objects in the zone of interest.

In some aspects, the sensing measurement information may include CERs for respective TRPs 705. For example, the UE(s) 120 may measure CIRs for the respective TRPs via measurement(s) of the sensing signals transmitted by the respective TRPs 705. The UE(s) 120 may obtain CERs for the respective TRPs 705 using the measured CIRs. For example, for a given UE 120 and a given TRP 705, the given UE 120 may measure or obtain one or more CIR taps or samples (e.g., over time). The CER for the given TRP 705 may include the CIR taps for the given TRP 705 as measured by the given UE 120. For example, the UE 120 may compute the CER from the CIRs measured via transmit (Tx) beam and receive (Rx) beam pairs of the given TRP 705. The given UE 120 may sum CERs from the Tx beam and Rx beam pairs. The UE 120 may determine an average CER for the given TRP 705 using the summed CERs for all Tx beam and Rx beam pairs of the given TRP 705. This may reduce a dimensionality of the CER data used as described elsewhere herein, thereby reducing a complexity of other operations described herein. The given UE 120 may obtain an average CER for each TRP 705 of the one or more TRPs in a similar manner. Additionally, each UE 120 (e.g., of the one or more UEs 120 selected for the cooperative multistatic RF sensing operation) may obtain CER data (e.g., average CERs) for each TRP 705 of the one or more TRPs in a similar manner.

The UE(s) 120 may perform one or more visualization operations using the sensing measurement information. The one or more visualization operations are depicted and described in more detail in connection with FIG. 8. As an example, as shown by reference number 740, the UE(s) 120 may generate one or more images that are representative of the CERs for each TRP 705. The UE(s) 120 may obtain the one or more images using the sensing measurement information.

For example, the UE(s) may generate, for each TRP from the one or more TRPs 705 and the one or more UEs 120, a CER image that includes one or more ellipses for respective channel taps of a CER for that TRP as indicated by the sensing measurement information. From the CER of each TRP 705, the UE(s) 120 may generate an ellipsoid for each tap (or samples) of the CER (e.g., in the delay domain). For example, as described elsewhere herein, a CER tap (or sample) may be represented as an ellipsoid in the 3D space. The UE(s) 120 may generate a CER image for a given TRP by projecting the ellipsoid(s) (e.g., representing the CER taps for the CER of the given TRP) on a 2D plane at a height of interest indicated by the RF sensing (e.g., performed by the network node 110 as described in connection with reference number 720). As a result, a CER measured for a TRP may be converted to a CER image that contains ellipses (e.g., one ellipse for each channel tap of the CER).

The height of interest may be a height at which target objects are expected to be located in the zone of interest. The network node 110 may determine the height of interest based on performing the monostatic RF sensing of the area that includes the zone of interest, as described elsewhere herein. In some aspects, the height of interest may be ground level (e.g., a height at which the ground or floor is located). For example, target objects in the zone of interest may be expected to be located at ground level (e.g., on the ground or floor). In some aspects, the network node 110 may transmit, and the UE(s) 120 may receive, an indication of the height of interest (e.g., in the configuration information or the sensing configuration information).

The UE(s) 120 may generate CER images for each TRP 705 in a similar manner. For example, the UE(s) 120 may generate a set of ellipses for each TRP (e.g., in a CER image). As described elsewhere herein, a potential location of a target object may be indicated via intersections of two or more ellipses from the CER images. Therefore, the UE(s) 120 may combine two or more CER images to represent the potential locations of target objects in the zone of interest (e.g., via intersections between two or more ellipses in a combined image). In some aspects, the network node 110 may combine all CER images to form a combined image (e.g., a single combined image). In other aspects, the UE(s) 120 may generate combined images for two or more TRPs 705. For example, the UE(s) 120 may generate multiple summed or combined images using CER images for two or more TRPs 705. This may reduce a complexity and processing overhead that may have otherwise been associated with combining all of the CER images into a single combined image. For example, combining all CER images into a single image may result in a complicated image with many patterns to be processed to obtain localization information for target objects. Using less than all TRPs to generate a combined image may result in a less complicated image, thereby reducing the complexity and processing overhead associated with obtaining the localization information, as described elsewhere herein.

For example, the UE(s) 120 may generate all possible TRP pairs from the one or more TRPs 705. For example, if the one or more TRPs 705 include a TRP 1, a TRP 2, a TRP 3, and a TRP 4, then the TRP pairs may include {TRP 1, TRP 2}, {TRP 1, TRP 3}, {TRP 1, TRP 4}, {TRP 2, TRP 3}, {TRP 2, TRP 4}, and {TRP 3, TRP 4}.

The UE(s) 120 may generate summed or combined images for each TRP pair using CER image(s) associated with TRPs included in the TRP pair. For example, the UE(s) 120 may generate, for each TRP pair, an image that is a summed image of a first CER image associated with a first TRP 705 included in that TRP pair and a second CER image associated with a second TRP 705 included in that TRP pair.

As shown by reference number 745, the UE(s) 120 may obtain summary vectors for respective images. In some aspects, the UE(s) 120 may obtain summary vectors for respective combined images (e.g., generated by the network node 110 as described in connection with reference number 745). The UE(s) 120 may obtain the summary vectors via a vision transformer, as described in more detail elsewhere herein.

As shown by reference number 750, the UE(s) 120 may transmit, and the network node 110 may receive, sensing result information. The sensing result information may be associated with one or more images that are representative of CERs for respective TRPs 705. For example, the sensing result information may be associated with the one or more images in that the sensing result information may include information associated with the one or more images, as described elsewhere herein. The sensing result information may include the one or more images. As another example, the sensing result information may include summary vectors for one or more images.

As shown by reference number 755, the network node 110 may obtain localization information using a DETR model. The localization information may indicate information for one or more objects (e.g., target objects) in the zone of interest. The network node 110 may obtain the localization information using the summary vectors of the sensing result information. For example, the network node 110 may obtain the localization information using the summary vectors of images (e.g., combined images) that are representative of CERs measured by UE(s) 120, as described in more detail elsewhere herein.

For example, the network node 110 may provide, as an input to the DETR model (e.g., to an encoder of the DETR model) the one or more summary vectors. The encoder of the DETR model may output one or more output vectors. The network node 110 may provide, as an input to a decoder of the DETR model, the one or more output vectors and one or more object queries. The one or more object queries may be queries for localization information for respective potential target objects. The decoder of the DETR model may output localization information for each object query. For example, the network node 110 may use DETR decoder output vectors to compute the coordinate locations of the targets and/or a probability of whether a target object is present or absent, among other examples. For example, the localization information may include an indication of probability information indicating a likelihood that the one or more objects are present in the zone of interest. Additionally, the localization information may include an indication of coordinate locations for respective objects of the one or more objects. The DETR model architecture is depicted and described in more detail in connection with FIG. 9.

As indicated above, FIG. 7 is provided as an example. Other examples may differ from what is described with respect to FIG. 7.

FIG. 8 is a diagram of an example 800 associated with a visualization operation for object localization using RF sensing and computer vision, in accordance with the present disclosure. In some aspects, the visualization operation depicted in FIG. 8 may be performed by a wireless communication device. In some aspects, the wireless communication device may be a network node 110 (e.g., a base station or a network server). In other aspects, the wireless communication device may be a UE 120. The visualization operation depicted in FIG. 8 may be used to generate CER images, as described in more detail elsewhere herein. A CER image may represent CIR data, a UE location (e.g., receiving device location), and a TRP location (e.g., a transmitting device location) in an image. This may enable computer vision and/or transformer techniques to be used to obtain localization information for one or more objects (e.g., device-free objects) in a zone of interest.

In a first operation 805, the wireless communication device may obtain CIR data. The CIR data may be obtained via one or more RF sensing measurements, as described in more detail elsewhere herein. In some aspects, the CIR data may include data obtained via measurements of sensing signals transmitted by one or more TRPs. In some aspects, the CIR data may include data obtained via measurements performed by one or more UEs. The CIR data may include CIRs obtained via measurements performed using one or more Tx-Rx beam pairs. A Tx-Rx beam pair may include a Tx beam used to transmit a signal (e.g., by a TRP) and an Rx beam used to receive or measure the signal (e.g., by a UE). The CIR data may include a quantity of taps or samples in the delay domain.

In a second operation 810, the wireless communication device may sum the CIR data over all Tx-Rx beam pairs. For example, for a given UE and a given TRP, the wireless communication device may determine an average CIR over all Tx-Rx beam pairs. The wireless communication device may sum the all Tx-Rx beam pairs for each UE and each TRP. This may reduce a dimensionality of the CIR data used to generate the images, as described herein.

In a third operation 815, the wireless communication device may normalize the CIR data. For example, the wireless communication device may normalize the CIR data such that the CIR data falls within a given range, such as [0, 1](e.g., where 0 represents the minimum value in the original CIR data and 1 represents the maximum value in the original CIR data). Normalizing the CIR data may ensure that data included in the CIR data having different features or variables with different scales contribute equally to the generation of the images, as described herein. Normalization may be performed for each TRP (e.g., for each TRP separately).

In some aspects, the third operation 815 may include removing a first one or more taps or samples from the CIR data before normalizing the CIR data. For example, a first one or more taps or samples from the CIR data may be from an LOS path between a UE and a TRP (e.g., between a receiving device and a transmitting device). The LOS path may not provide relevant information for object detection or localization (e.g., because the signal is not reflected by a target object in the LOS path). Therefore, the wireless communication device may remove a first X taps or samples from the CIR data before performing the third operation 815 (e.g., to remove CIR data of the LOS path and any sidelobes of the LOS path).

A resulting data matrix may be formed including normalized CIR data for respective TRPs. For example, the data matrix may have dimensions of U by P, where U is the quantity of UEs (e.g., receiving devices) and P is a quantity of CIR taps or samples included in the CIR data. In examples where the wireless communication device is a UE, the value of U may be one (1). If there are T TRPs, then the wireless communication device may generate T data matrices.

In a fourth operation 820, the wireless communication device may determine whether images have been generated for all TRPs and/or for all UE-TRP pairs. For example, if the wireless communication device is a UE, then the fourth operation 820 may include determining whether images have been generated for all TRPs. If the wireless communication device is a network node, then the fourth operation 820 may include determining whether images have been generated for all UE-TRP pairs. If the wireless communication device determines that images have not been generated for all TRPs or all UE-TRP pairs (“No” in the fourth operation 820), then the wireless communication device may determine (e.g., for a given TRP or a given UE-TRP pair) whether an ellipse has been generated for all CIR taps (in a fifth operation 825).

If the wireless communication device determines that an ellipse has not been generated for all CIR taps (“No” in the fifth operation 825), then the wireless communication device may generate an ellipsoid for a given CIR (or CER) tap or sample (in a sixth operation 830). For example, for each CIR tap, the wireless communication device may generate an ellipsoid in the 3D space, as described elsewhere herein. In a seventh operation 835, the wireless communication device may generate an ellipse image on a 2D plane by projecting the ellipsoid at a height of interest. The ellipse image may be an ellipse having focal points that correspond to a UE location and a TRP location (e.g., where a potential target object is located somewhere on the ellipse, as described elsewhere herein).

If the wireless communication device determines that an ellipse has been generated for all CIR taps (“Yes” in the fifth operation 825), then the wireless communication device may combine the ellipses into a single image to generate a CER image for a given TRP or for a given UE-TRP pair (e.g., in an eighth operation 840). As a result, the CER image may be representative of the CIR data, a UE location, and a TRP location for a given TRP or for a given UE-TRP pair. The wireless communication device may repeat the fifth operation 825, the sixth operation 830, the seventh operation 835, and the eighth operation 840 for each TRP and/or for each UE-TRP pair. For example, if the wireless communication device determines that images have been generated for all TRPs or all UE-TRP pairs (“Yes” in the fourth operation 820), then the visualization operation may be completed.

As indicated above, FIG. 8 is provided as an example. Other examples may differ from what is described with respect to FIG. 8.

FIG. 9 is a diagram of an example 900 associated with a transformer architecture for object localization using RF sensing and computer vision, in accordance with the present disclosure. As shown in FIG. 9, a DETR model 905 and one or more vision transformers 910 may be used to obtain localization information for one or more target objects in an environment, as described in more detail elsewhere herein. The DETR model 905 may include a DETR encoder 915 and a DETR decoder 920.

As shown in FIG. 9, one or more images 925 may be input to the one or more vision transformers 910. Each of the vision transformers 910 may share the same parameter values, such as weights and biases. The one or more images 925 may be representative of CIR or CER data, UE locations (e.g., receiving device locations), and TRP locations (e.g., transmitting device locations) for a cooperative multistatic RF sensing operation. The one or more images 925 may be CER images or combined images (e.g., combining CER images for two or more TRPs), as described in more detail elsewhere herein.

An output of the one or more vision transformers 910 may include summary vectors 930 for respective images of the one or more images 925. For example, an image (e.g., a combined image representative of CERs for two or more TRPs and a given UE) may be an input to a vision transformer 910. The image may be divided into a set of patches. Each patch may be projected by a linear layer into a vector. In some aspects, the vision transformer 910 may include positional encoding that encodes an order of the patches (e.g., by adding an additional learnable vector having the same dimension as the vectors of the patches). The vision transformer 910 may prepend a trainable embedding token vector before the patch vectors. The embedding token vector may be a classification token used to represent the entire input sequence of vectors. For example, the embedding token vector may be used to represent the entire image. The embedding token vector may be similar to a CLS token for a BERT model. The summary vectors 930 may be an output vector for an image 925 corresponding to the embedding token vector. For example, each output vector of the transformer encoder may include context information from all other inputs. Therefore, the first output vector may serve as a “summary” of the image 925 input to the vision transformer 910.

As shown in FIG. 9, the summary vectors 930 may be input to the DETR encoder 915 of the DETR model 905. The DETR encoder 915 may output one or more output vectors. The one or more output vectors of the DETR encoder 915 may be input to the DETR decoder 920, and serve as keys and values for multi-head cross-attention layers of the DETR decoder 920. Additionally, one or more object queries 935 may be input to the DETR decoder 920. The one or more object queries 935 may be queries for localization information for respective potential target objects. The DETR decoder 920 of the DETR model 905 may output localization information for each object query 935. For example, if there are W object queries, then the DETR decoder 920 may output W output vectors corresponding to W potential objects. This enables the DETR model 905 to output localization information for a dynamic quantity of target objects. The DETR decoder 920 may include a multi-head self-attention layer, a multi-head cross-attention layer, and a feedforward layer.

As an example, if there are 20 object queries 935 and 5 objects in the environment, then the DETR model 905 may output 20 output vectors, where 5 output vectors may indicate non-empty results and 15 output vectors may indicate empty results. Each of the output vectors of the DETR model may be input to two linear layers as output branches. A first output branch (e.g., an upper branch) may be associated with predicting whether an object query is empty. For example, the first output branch may include information indicating a probability of whether the object query is empty. An object query being empty may be indicative of no object being detected, whereas an object query being non-empty may be indicative of an object being detected. A second output branch (e.g., a lower branch) may be associated with predicting a location (e.g., a coordinate location) of an object associated with a given object query. Only output branches that indicate non-empty results in the first output branch may have relevant information in the second output branch.

By encoding CIR data, UE locations, and TRP locations into images (e.g., as described elsewhere herein, such as in connection with FIG. 8) and using a vision transform and DETR deep learning model to process the images, localization information 940 may be obtained for one or more objects (e.g., device-free objects) in an environment. The localization information 940 may indicate a quantity of target objects detected in a zone of interest and/or predicted locations of detected target objects, among other examples.

The model depicted in FIG. 9 may be trained using two or more losses. For example, the model depicted in FIG. 9 may be trained using training data. The training data may include training images having labels indicating target object locations. During training, a first loss associated with identifying a correct quantity of target objects may be calculated. The first loss may be a cross-entropy loss. The second loss may be associated with identifying correct locations of detected objects. The second loss may be a mean square error loss. For example, a final loss for training the DETR model 905 may be L=L_{ce}+λLₘₛₑ, where L_{ce} is the first loss, Lₘₛₑ is the second loss, and λ is a hyperparameter. Training may include back-propagating the loss throughout the architecture depicted in FIG. 9 to optimize a neural network associated with the architecture.

As indicated above, FIG. 9 is provided as an example. Other examples may differ from what is described with respect to FIG. 9.

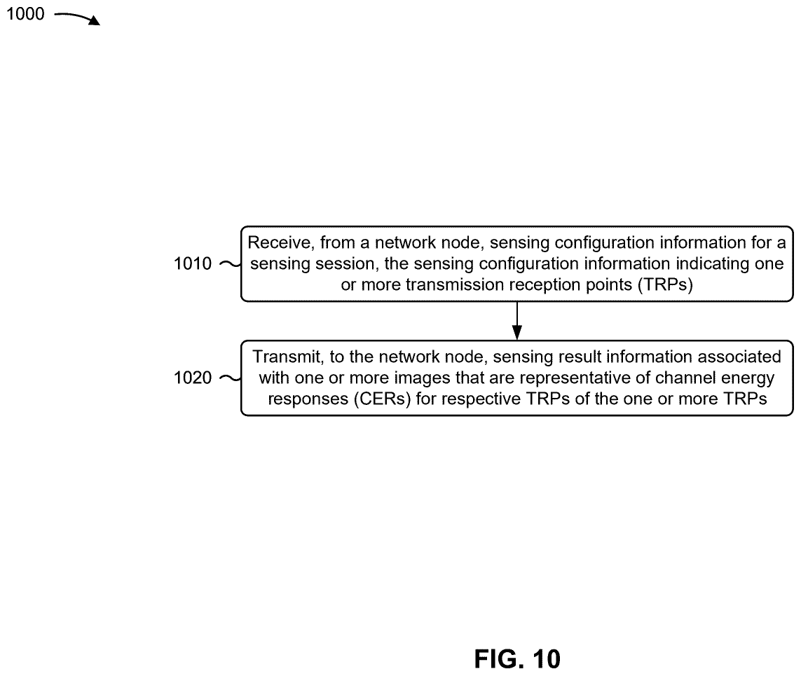

FIG. 10 is a flowchart of an example process 1000 associated with object localization using RF sensing and computer vision, in accordance with the present disclosure. In some aspects, one or more process blocks of FIG. 10 are performed by a UE (e.g., UE 120). In some aspects, one or more process blocks of FIG. 10 are performed by another device or a group of devices separate from or including the UE, such as a network node 110. Additionally, or alternatively, one or more process blocks of FIG. 10 may be performed by one or more components of device 200, such as processor 210, memory 215, input component 220, output component 225, communication component 230, RF sensing component 235, image generation component 240, and/or object localization component 245.

As shown in FIG. 10, process 1000 may include receiving, from a network node, sensing configuration information for a sensing session, the sensing configuration information indicating one or more TRPs (block 1010). For example, the UE may receive, from a network node, sensing configuration information for a sensing session, the sensing configuration information indicating one or more TRPs, as described above.

As further shown in FIG. 10, process 1000 may include transmitting, to the network node, sensing result information associated with one or more images that are representative of CERs for respective TRPs of the one or more TRPs (block 1020). For example, the UE may transmit, to the network node, sensing result information associated with one or more images that are representative of CERs for respective TRPs of the one or more TRPs, as described above.

Process 1000 may include additional aspects, such as any single aspect or any combination of aspects described below and/or in connection with one or more other processes described elsewhere herein.

In a first aspect, the sensing result information includes the CERs.

In a second aspect, alone or in combination with the first aspect, the sensing result information includes an average CER for each TRP of the one or more TRPs.

In a third aspect, alone or in combination with one or more of the first and second aspects, the sensing configuration information indicates that the UE is to measure signals associated with the one or more TRPs to obtain the CERs.

In a fourth aspect, alone or in combination with one or more of the first through third aspects, a CER for a TRP, included in the one or more TRPs, includes CIR taps for the TRP as measured by the UE in accordance with the sensing configuration information.

In a fifth aspect, alone or in combination with one or more of the first through fourth aspects, the sensing result information includes one or more summary vectors for respective images of the one or more images.

In a sixth aspect, alone or in combination with one or more of the first through fifth aspects, the one or more summary vectors are representative of summed images of images, of the one or more images, associated with two or more TRPs of the one or more TRPs.

In a seventh aspect, alone or in combination with one or more of the first through sixth aspects, the one or more summary vectors are indicative of localization information for one or more objects in a zone of interest associated with the sensing session.

In an eighth aspect, alone or in combination with one or more of the first through seventh aspects, receiving the sensing configuration information includes receiving an indication of a height of interest that is associated with the one or more images.

In a ninth aspect, alone or in combination with one or more of the first through eighth aspects, process 1000 includes obtaining, using a computer vision model, the one or more images using the CERs.

Although FIG. 10 shows example blocks of process 1000, in some aspects, process 1000 includes additional blocks, fewer blocks, different blocks, or differently arranged blocks than those depicted in FIG. 10. Additionally, or alternatively, two or more of the blocks of process 1000 may be performed in parallel.

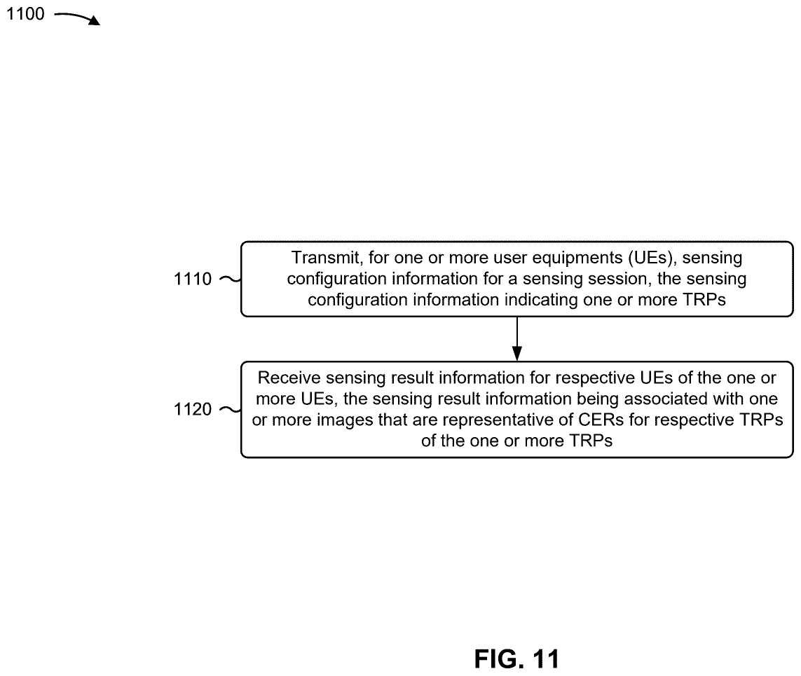

FIG. 11 is a flowchart of an example process 1100 associated with object localization using RF sensing and computer vision, in accordance with the present disclosure. In some aspects, one or more process blocks of FIG. 11 are performed by a network node (e.g., network node 110). In some aspects, one or more process blocks of FIG. 11 are performed by another device or a group of devices separate from or including the network node, such as a UE 120. Additionally, or alternatively, one or more process blocks of FIG. 11 may be performed by one or more components of device 200, such as processor 210, memory 215, input component 220, output component 225, communication component 230, RF sensing component 235, image generation component 240, and/or object localization component 245.

As shown in FIG. 11, process 1100 may include transmitting, for one or more UEs, sensing configuration information for a sensing session, the sensing configuration information indicating one or more TRPs (block 1110). For example, the network node may transmit, for one or more UEs, sensing configuration information for a sensing session, the sensing configuration information indicating one or more TRPs, as described above.

As further shown in FIG. 11, process 1100 may include receiving sensing result information for respective UEs of the one or more UEs, the sensing result information being associated with one or more images that are representative of CERs for respective TRPs of the one or more TRPs (block 1120). For example, the network node may receive sensing result information for respective UEs of the one or more UEs, the sensing result information being associated with one or more images that are representative of CERs for respective TRPs of the one or more TRPs, as described above.

Process 1100 may include additional aspects, such as any single aspect or any combination of aspects described below and/or in connection with one or more other processes described elsewhere herein.

In a first aspect, receiving the sensing result information includes receiving, from each UE of the one or more UEs, one or more CERs for the respective TRPs.

In a second aspect, alone or in combination with the first aspect, receiving the sensing result information includes receiving, from each UE of the one or more UEs, average CERs associated with the respective TRPs.

In a third aspect, alone or in combination with one or more of the first and second aspects, the sensing configuration information indicates that the one or more UEs are to measure signals associated with the one or more TRPs to obtain the CERs.

In a fourth aspect, alone or in combination with one or more of the first through third aspects, a CER for a TRP, included in the one or more TRPs, includes CIR taps for the TRP as measured by a UE of the one or more UEs in accordance with the sensing configuration information.

In a fifth aspect, alone or in combination with one or more of the first through fourth aspects, receiving the sensing result information includes receiving, for each UE of the one or more UEs, one or more summary vectors for respective images of the one or more images.

In a sixth aspect, alone or in combination with one or more of the first through fifth aspects, the one or more summary vectors are representative of summed images of images, of the one or more images, associated with two or more TRPs of the one or more TRPs.

In a seventh aspect, alone or in combination with one or more of the first through sixth aspects, the one or more summary vectors are indicative of localization information for one or more objects in a zone of interest associated with the sensing session.

In an eighth aspect, alone or in combination with one or more of the first through seventh aspects, transmitting the sensing configuration information includes transmitting an indication of a height of interest that is associated with the one or more images.

In a ninth aspect, alone or in combination with one or more of the first through eighth aspects, process 1100 includes obtaining localization information, using the sensing result information, for one or more objects in a zone of interest associated with the sensing session.

In a tenth aspect, alone or in combination with one or more of the first through ninth aspects, obtaining the localization information includes obtaining, using a computer vision model, the one or more images using the sensing result information, and obtaining, using a machine learning model, the localization information using the one or more images.

Although FIG. 11 shows example blocks of process 1100, in some aspects, process 1100 includes additional blocks, fewer blocks, different blocks, or differently arranged blocks than those depicted in FIG. 11. Additionally, or alternatively, two or more of the blocks of process 1100 may be performed in parallel.

The following provides an overview of some Aspects of the present disclosure:

Aspect 1: A method performed by a user equipment (UE), comprising: receiving, from a network node, sensing configuration information for a sensing session, the sensing configuration information indicating one or more transmission reception points (TRPs); and transmitting, to the network node, sensing result information associated with one or more images that are representative of channel energy responses (CERs) for respective TRPs of the one or more TRPs.

Aspect 2: The method of Aspect 1, wherein the sensing result information includes the CERs.

Aspect 3: The method of any of Aspects 1-2, wherein the sensing result information includes an average CER for each TRP of the one or more TRPs.

Aspect 4: The method of any of Aspects 1-3, wherein the sensing configuration information indicates that the UE is to measure signals associated with the one or more TRPs to obtain the CERs.

Aspect 5: The method of any of Aspects 1-4, wherein a CER for a TRP, included in the one or more TRPs, includes channel impulse response (CIR) taps for the TRP as measured by the UE in accordance with the sensing configuration information.

Aspect 6: The method of any of Aspects 1-5, wherein the sensing result information includes one or more summary vectors for respective images of the one or more images.

Aspect 7: The method of Aspect 6, wherein the one or more summary vectors are representative of summed images of images, of the one or more images, associated with two or more TRPs of the one or more TRPs.

Aspect 8: The method of any of Aspects 6-7, wherein the one or more summary vectors are indicative of localization information for one or more objects in a zone of interest associated with the sensing session.

Aspect 9: The method of any of Aspects 1-8, wherein receiving the sensing configuration information comprises: receiving an indication of a height of interest that is associated with the one or more images.

Aspect 10: The method of any of Aspects 1-9, further comprising: obtaining, using a computer vision model, the one or more images using the CERs.

Aspect 11: A method performed by a network node, comprising: transmitting, for one or more user equipments (UEs), sensing configuration information for a sensing session, the sensing configuration information indicating one or more transmission reception points (TRPs); and receiving sensing result information for respective UEs of the one or more UEs, the sensing result information being associated with one or more images that are representative of channel energy responses (CERs) for respective TRPs of the one or more TRPs.

Aspect 12: The method of Aspect 11, wherein receiving the sensing result information comprises: receiving, from each UE of the one or more UEs, one or more CERs for the respective TRPs.

Aspect 13: The method of any of Aspects 11-12, wherein receiving the sensing result information comprises: receiving, from each UE of the one or more UEs, average CERs associated with the respective TRPs.

Aspect 14: The method of any of Aspects 11-13, wherein the sensing configuration information indicates that the one or more UEs are to measure signals associated with the one or more TRPs to obtain the CERs.

Aspect 15: The method of any of Aspects 11-14, wherein a CER for a TRP, included in the one or more TRPs, includes channel impulse response (CIR) taps for the TRP as measured by a UE of the one or more UEs in accordance with the sensing configuration information.

Aspect 16: The method of any of Aspects 11-15, wherein receiving the sensing result information comprises: receiving, for each UE of the one or more UEs, one or more summary vectors for respective images of the one or more images.

Aspect 17: The method of Aspect 16, wherein the one or more summary vectors are representative of summed images of images, of the one or more images, associated with two or more TRPs of the one or more TRPs.

Aspect 18: The method of any of Aspects 16-17, wherein the one or more summary vectors are indicative of localization information for one or more objects in a zone of interest associated with the sensing session.

Aspect 19: The method of any of Aspects 11-18, wherein transmitting the sensing configuration information comprises: transmitting an indication of a height of interest that is associated with the one or more images.

Aspect 20: The method of any of Aspects 11-19, further comprising: obtaining localization information, using the sensing result information, for one or more objects in a zone of interest associated with the sensing session.

Aspect 21: The method of Aspect 20, wherein obtaining the localization information comprises: obtaining, using a computer vision model, the one or more images using the sensing result information; and obtaining, using a machine learning model, the localization information using the one or more images.

Aspect 22: A system configured to perform one or more operations recited in one or more of Aspects 1-21.

Aspect 23: An apparatus comprising means for performing one or more operations recited in one or more of Aspects 1-21.

Aspect 24: A non-transitory computer-readable medium storing a set of instructions, the set of instructions comprising one or more instructions that, when executed by a device, cause the device to perform one or more operations recited in one or more of Aspects 1-21.

Aspect 25: A computer program product comprising instructions or code for executing one or more operations recited in one or more of Aspects 1-21.

Aspect 26: A device comprising one or more memories; and one or more processors, coupled to the one or more memories, configured to cause the device to perform one or more operations recited in one or more of Aspects 1-21.

Aspect 27: An apparatus at a device, the apparatus comprising one or more processors; one or more memories coupled with the one or more processors; and instructions stored in the one or more memories and executable by the one or more processors to cause the apparatus to perform the method of one or more of Aspects 1-21.

Aspect 28: An apparatus at a device, the apparatus comprising one or more memories and one or more processors coupled to the one or more memories, the one or more processors configured to cause the device to perform the method of one or more of Aspects 1-21.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
one or more memories; and
one or more processors, coupled to the one or more memories, configured to cause the UE to:
receive, from a network node, sensing configuration information for a sensing session, the sensing configuration information indicating one or more transmission reception points (TRPs); and
transmit, to the network node, sensing result information associated with one or more images that are representative of channel energy responses (CERs) for respective TRPs of the one or more TRPs.

2. The UE of claim 1, wherein the sensing result information includes the CERs.

3. The UE of claim 1, wherein the sensing result information includes an average CER for each TRP of the one or more TRPs.

4. The UE of claim 1, wherein the sensing configuration information indicates that the UE is to measure signals associated with the one or more TRPs to obtain the CERs.

5. The UE of claim 1, wherein a CER for a TRP, included in the one or more TRPs, includes channel impulse response (CIR) taps for the TRP as measured by the UE in accordance with the sensing configuration information.

6. The UE of claim 1, wherein the sensing result information includes one or more summary vectors for respective images of the one or more images.

7. The UE of claim 6, wherein the one or more summary vectors are representative of summed images of images, of the one or more images, associated with two or more TRPs of the one or more TRPs.

8. The UE of claim 6, wherein the one or more summary vectors are indicative of localization information for one or more objects in a zone of interest associated with the sensing session.

9. The UE of claim 1, wherein the one or more processors, to cause the UE to receive the sensing configuration information, are configured to cause the UE to:
receive an indication of a height of interest that is associated with the one or more images.

10. A network node, comprising:
one or more memories; and
one or more processors, coupled to the one or more memories, configured to cause the network node to:
transmit, for one or more user equipments (UEs), sensing configuration information for a sensing session, the sensing configuration information indicating one or more transmission reception points (TRPs); and
receive sensing result information for respective UEs of the one or more UEs, the sensing result information being associated with one or more images that are representative of channel energy responses (CERs) for respective TRPs of the one or more TRPs.

11. The network node of claim 10, wherein the one or more processors, to cause the network node to receive the sensing result information, are configured to cause the network node to:
receive, from each UE of the one or more UEs, one or more CERs for the respective TRPs.

12. The network node of claim 10, wherein the sensing configuration information indicates that the one or more UEs are to measure signals associated with the one or more TRPs to obtain the CERs.

13. The network node of claim 10, wherein the one or more processors, to cause the network node to receive the sensing result information, are configured to cause the network node to:
receive, for each UE of the one or more UEs, one or more summary vectors for respective images of the one or more images.

14. The network node of claim 13, wherein the one or more summary vectors are representative of summed images of images, of the one or more images, associated with two or more TRPs of the one or more TRPs.

15. The network node of claim 10, wherein the one or more processors, to cause the network node to transmit the sensing configuration information, are configured to cause the network node to:
transmit an indication of a height of interest that is associated with the one or more images.

16. The network node of claim 10, wherein the one or more processors are further configured to cause the network node to:
obtain localization information, using the sensing result information, for one or more objects in a zone of interest associated with the sensing session.

17. A method performed by a user equipment (UE), comprising:
receiving, from a network node, sensing configuration information for a sensing session, the sensing configuration information indicating one or more transmission reception points (TRPs); and
transmitting, to the network node, sensing result information associated with one or more images that are representative of channel energy responses (CERs) for respective TRPs of the one or more TRPs.

18. The method of claim 17, wherein the sensing result information includes the CERs.

19. The method of claim 17, wherein the sensing result information includes one or more summary vectors for respective images of the one or more images.

20. The method of claim 19, wherein the one or more summary vectors are representative of summed images of images, of the one or more images, associated with two or more TRPs of the one or more TRPs.
